(19) United States
(12) Patent Application Publication
(10) Pub. No.: US 2015/0361257 A1
(43) Pub. Date: Dec. 17, 2015

(54) METHOD FOR PRODUCING SUBSTRATE HAVING PATTERN AND RESIN COMPOSITION FOR HYDROFLUORIC ACID ETCHING

(71) Applicant: NISSAN CHEMICAL INDUSTRIES, LTD., Chiyoda-ku, Tokyo (JP)

(72) Inventor: Tetsuo SATO, Funabashi-shi (JP)

(73) Assignee: NISSAN CHEMICAL INDUSTRIES, LTD., Chiyoda-ku, Tokyo (JP)

(21) Appl. No.: 14/764,114

(22) PCT Filed: Jan. 28, 2014
(86) PCT No.: PCT/JP2014/051809

§ 371 Date: Jul. 28, 2015

(30) Foreign Application Priority Data
Jan. 28, 2013 (JP) 2013-013453
May 13, 2013 (JP) 2013-101676
Jun. 14, 2013 (JP) 2013-126136
Aug. 30, 2013 (JP) 2013-180387

(51) Int. Cl. C08L 47/00; C08K 5/09; C08K 5/053; C08K 5/20; C08K 5/54; C08F 236/14; C08K 3/36

(52) U.S. Cl. CPC C08L 47/00; C08F 236/14; C08K 5/09; C08K 3/36; C08K 5/20; C08K 5/54; C08K 5/053; C08L 2203/16

(57) ABSTRACT

The method of the invention for producing a substrate having a pattern includes a step of forming a resist film by applying, onto a substrate, a composition containing a resin as component (A), the resin being formed through reaction between a polyol (a1) and a cross-linking agent (a2), the polyol (a1) being selected from among a polybutadiene polyol, a hydrogenated polybutadiene polyol, a polyisoprene polyol, and a hydrogenated polyisoprene polyol, and a step of patterning, through etching, the substrate on which the resist film has been formed.

### TECHNICAL FIELD

The present invention relates to a resin composition suitable for forming a resist film employed in etching of a glass substrate or a substrate coated with insulating film, and to a method for producing a substrate having an etching pattern formed by use of the composition.

### BACKGROUND ART

Wet etching is a widely employed technique of processing a substrate and is carried out in various steps involved in processing large-scale substrates of flat-panel displays.

Specifically, in relation to a glass-made rear-face cap of an organic electroluminescence display (organic ELD), efforts have been made toward reduction in thickness of the ELD panel. The glass-made rear-face cap is formed by etching a glass substrate. In the etching process, a resist film is formed on the glass substrate, and only a region of interest is subjected to etching.

Hitherto, a variety of resist resin compositions have been employed as a mask material for use in wet etching. Such a resist resin composition is applied onto a glass substrate or a substrate having an insulating film (e.g., SiO₂ or SiN) and patterned. Thereafter, the substrate is immersed, for etching, in an etching liquid (hereinafter may be referred to as an “etchant”) containing, for example, hydrofluoric acid (HF).

However, in the case where adhesion between a substrate and a resist film is poor, the resist film is peeled from the substrate, and the amount of side etching increases, resulting in impairment of etching precision, which is problematic. In addition, when etching for a long time is required, pinholes are provided in the resist film, or a resist coating swells, resulting in peeling of the resist film from the substrate, which is problematic. In the case where a silane coupling agent has been incorporated into a resist film for enhancing adhesion, the silane coupling agent remains on the substrate after removal of the resist film. The remaining silane coupling agent problematically contaminates the substrate.

Among various acids, hydrofluoric acid has high permeability. Thus, difficulty is encountered in producing a film having a hydrofluoric acid barrier property. In this connection, several patent applications relating to hydrofluoric acid-resistant resists for glass etching were previously filed. These patent applications include imparting a gas-barrier property to a resist through addition of a filler thereto (see, for example, Patent Documents 1 and 2), a composition containing an alkali-soluble resin and an acrylic monomer (see, for example, Patent Documents 3 to 7), and an aromatic polyarylate resin (e.g., Patent Document 8). However, there has been no case in which use of a silane coupling agent is avoided by use of an adhesive.

The mask material made of a resist resin composition is removed from the substrate after etching, through washing with a remover liquid or through peeling by hand. In order to ensure adhesion between the resist resin composition and the substrate, in some cases, an acrylic adhesive is used. Generally, an acrylic adhesive is known to have high susceptibility to hydrochloric acid and sulfuric acid contained in an etching liquid; i.e., to have intrinsically low acid resistance. In order to overcome the drawback, there have been proposed a technique in which a radiation-curable adhesive is applied onto a radiation-transmitting film substrate having acid resistance, in order to enhance acid resistance (see, for example, Patent Document 9); a technique in which an adhesive is hydrophobicized by use of a C8 acrylate ester (see, for example, Patent Document 10); a technique in which an adhesive containing as a predominant component a monomer having a C≧6 alkyl group is used (see, for example, Patent Document 11); and other techniques. However, no acrylic adhesive has been verified to have hydrofluoric acid resistance, and there has not been reported use of an acrylic adhesive in a resin composition for etching with hydrofluoric acid.

### PRIOR ART DOCUMENTS

### Patent Documents

Patent Document 1: Japanese Patent Application Laid-Open (kokai) No. 2005-164877
Patent Document 2: Japanese Patent Application Laid-Open (kokai) No. 2007-128052
Patent Document 3: Japanese Patent Application Laid-Open (kokai) No. 2010-72518
Patent Document 4: Japanese Patent Application Laid-Open (kokai) No. 2008-233346
Patent Document 5: Japanese Patent Application Laid-Open (kokai) No. 2008-76768
Patent Document 6: Japanese Patent Application Laid-Open (kokai) No. 2009-163080
Patent Document 7: Japanese Patent Application Laid-Open (kokai) No. 2006-337670
Patent Document 8: Japanese Patent Application Laid-Open (kokai) No. 2010-256788
Patent Document 9: Japanese Patent Application Laid-Open (kokai) No. Hei 5-195255
Patent Document 10: Japanese Patent Application Laid-Open (kokai) No. Hei 9-134991
Patent Document 11: Japanese Patent Application Laid-Open (kokai) No. 2013-40323

### SUMMARY OF THE INVENTION

### Problems to be Solved by the Invention

Generally, organic film cannot prevent penetration of hydrofluoric acid (HF), resulting in corrosion of a substrate and peeling of the film from the substrate. Also, such organic film is immediately dissolved in high-concentration nitric acid (HNO₃) employed for washing a substrate. Under such circumstances, an object of the present invention is to provide a resin composition suitable for forming a resist film in etching of a glass substrate or a substrate having an insulating film (e.g., SiO₂ or SiN). Another object is to provide a method for producing various substrates by use of the composition.

More particularly, an object of the present invention is to provide a resin composition which has sufficient resistance to an etchant containing, for example, hydrofluoric acid, and has sufficient adhesion to a glass substrate or a substrate having an insulating film (e.g., SiO₂ or SiN); which is resistant to side etching in wet etching, to thereby provide a resist film which cannot be peeled by long-term etching and which realizes formation of a pattern of interesting at high precision; and which can be readily removed from after patterning. Another object is to provide a method for producing various substrates by use of the composition.

### Means for Solving the Problems

The present inventor has conducted extensive studies in order to attain the aforementioned objects, and has found that the objects can be attained by a polyester resin and/or polyurethane resin produced from a polybutadiene polyol as a raw material. The present invention has been accomplished on the basis of this finding.

1. A method for producing a substrate having a pattern, characterized in that the method comprises a step of forming a resist film by applying, onto a substrate, a composition containing a resin as component (A), the resin being formed through reaction between a polyol (a1) and a cross-linking agent (a2), the polyol (a1) being selected from among a polybutadiene polyol, a hydrogenated polybutadiene polyol, a polyisoprene polyol, and a hydrogenated polyisoprene polyol, and a step of patterning, through etching, the substrate on which the resist film has been formed.

2. A substrate production method as described in 1 above, wherein the reaction between the polyol (a1) and the cross-linking agent (a2) is ester bond formation reaction.

3. A substrate production method as described in 1 above, wherein the reaction between the polyol (a1) and the cross-linking agent (a2) is urethane bond formation reaction.

4. A substrate production method as described in any of 1 to 3 above, wherein the polyol (a1) is a hydrogenated polybutadiene polyol.

5. A substrate production method as described in any of 1 to 4 above, wherein the resin serving as component (A) further has a (meth)acrylate group.

6. A substrate production method as described in any of 1 to 5 above, wherein the resin serving as component (A) further has an alkali-soluble group.

7. A substrate production method as described in any of 1 to 6 above, wherein the composition further contains an ethylenic unsaturated monomer (B).

8. A substrate production method as described in 7 above, wherein the ethylenic unsaturated monomer (B) is a C≧6 aliphatic or alicyclic alkyl (meth)acrylate.

9. A substrate production method as described in any of 1 to 8 above, wherein the composition further contains at least one member selected from the group consisting of a photo-polymerization initiator (C) and a thermal-polymerization initiator (H).

10. A substrate production method as described in any of 1 to 9 above, wherein the composition further contains a gelling agent (J).

11. A substrate production method as described in any of 1 to 10 above, wherein the composition further contains a thixotropy-imparting agent (I).

12. A substrate production method as described in any of 1 to 11 above, wherein the composition further contains an acrylic adhesive (G).

13. A substrate production method as described in 12 above, wherein the acrylic adhesive (G) is composed of at least one (meth)acrylate selected from the group consisting of lauryl (meth)acrylate, isodecyl (meth)acrylate, 2-ethylhexyl (meth)acrylate, n-butyl (meth)acrylate, isobornyl (meth)acrylate, n-octyl (meth)acrylate, dicyclopentanylethyl (meth)acrylate, dicyclopentanyl acrylate, adamantyl (meth)acrylate, 2-methyl-2-adamantyl (meth)acrylate, and 2-ethyl-2-adamantyl (meth)acrylate.

14. A substrate production method as described in 12 or 13 above, wherein the composition contains the acrylic adhesive in an amount of 50 to 3,300 parts by mass, with respect to 100 parts by mass of the resin serving as component (A).

15. A substrate production method as described in any of 1 to 14 above, wherein the composition further contains an emulsifying agent (K).

16. A substrate production method as described in any of 1 to 15 above, wherein the composition is applied through spin coating, slit coating, roller coating, screen printing, or applicator coating.

17. A substrate production method as described in any of 1 to 16 above, wherein the substrate is a glass substrate.

18. A substrate production method as described in any of 1 to 16 above, wherein the substrate is a substrate coated with an insulating layer containing silicon.

19. A substrate production method as described in 18 above, wherein the insulating layer containing silicon is formed of SiO₂ or SiN.

20. A substrate production method as described in any of 1 to 19 above, wherein the etching is wet etching.

21. A substrate produced through a production method as recited in any of 1 to 20.

22. An electronic part employing a substrate as recited in 21.

23. A composition for hydrofluoric acid etching, the composition being a resist resin composition and comprising a resin, as component (A), the resin being produced through reaction between a polyol (a1) and a cross-linking agent (a2), the polyol (a1) being selected from among a polybutadiene polyol, a hydrogenated polybutadiene polyol, a polyisoprene polyol, and a hydrogenated polyisoprene polyol.

24. A resin composition for hydrofluoric acid etching as described in 23 above, which composition further contains an acrylic adhesive (G).

25. A resin composition for hydrofluoric acid etching as described in 24 above, wherein the acrylic adhesive (G) is composed of at least one (meth)acrylate selected from the group consisting of lauryl (meth)acrylate, isodecyl (meth)acrylate, 2-ethylhexyl (meth)acrylate, n-butyl (meth)acrylate, isobornyl (meth)acrylate, n-octyl (meth)acrylate, dicyclopentanylethyl (meth)acrylate, dicyclopentanyl acrylate, adamantyl (meth)acrylate, 2-methyl-2-adamantyl (meth)acrylate, and 2-ethyl-2-adamantyl (meth)acrylate.

26. A resin composition for hydrofluoric acid etching as described in 24 or 25 above, which composition contains the acrylic adhesive in an amount of 50 to 3,300 parts by mass, with respect to 100 parts by mass of the resin serving as component (A).

27. A resin composition for hydrofluoric acid etching as described in any of 23 to 26 above, which composition further contains at least one member selected from the group consisting of a photo-polymerization initiator (C) and a thermal-polymerization initiator (H).

28. A resin composition for hydrofluoric acid etching as described in any of 23 to 27 above, which composition further contains a gelling agent (J).

29. A resin composition for hydrofluoric acid etching as described in any of 23 to 28 above, which composition further contains an emulsifying agent (K).

30. A resin composition for hydrofluoric acid etching as described in any of 23 to 29 above, which composition further contains a thixotropy-imparting agent (I).

### Effects of the Invention

The resin of the invention in which the polybutadiene polyol (a1) and the cross-linking agent (a2) are linked via an ester bond or a urethane bond and an optional (meth)acrylate group and/or an optional alkali-soluble group is present exhibits an excellent hydrofluoric acid barrier property. The resin is not corroded by an acid or alkali at high concentration. In addition, the resin of the invention exhibits excellent adhesion to the substrate, even though the resin does not contain a silane coupling agent, which is conventionally used as an adhesive and causes contamination. Thus, the resin of the present invention is a very useful source for producing an acid- and alkali-barrier film which can be readily peeled after etching.

By use of the resin composition of the present invention, there can be provided a resist resin composition which has sufficient resistance to an etchant containing, for example, hydrofluoric acid, and has sufficient adhesion to a glass substrate or a substrate having an insulating film (e.g., SiO₂ or SiN); which is resistant to side etching in wet etching, to thereby provide a resist film which cannot be peeled by long-term etching and which realizes formation of a pattern of interest at high precision; and which can be readily removed from after patterning, whereby various substrates can be wet-etched at high precision.

### BRIEF DESCRIPTION OF THE DRAWINGS

FIG. 1 An enlarged image of a pattern of a substrate patterned through the production method of the present invention.

FIG. 2 Optical microscopic images of the surfaces of substrate (SiO₂) film after etching.

### MODES FOR CARRYING OUT THE INVENTION

Next will be described in detail a method of producing various substrates each having an etching pattern formed by use of the resin composition of the present invention.

### <Resin Composition>

A characteristic feature of the resin composition of the present invention resides in that the composition contains, as component (A), a resin which is formed from a polyol (a1) and a cross-linking agent (a2), the polyol (a1) being selected from among a polybutadiene polyol, a hydrogenated polybutadiene polyol, a polyisoprene polyol, and a hydrogenated polyisoprene polyol, wherein the polyol (a1) and the cross-linking agent (a2) are linked via an ester bond or a urethane bond, and which has an optional (meth)acrylate group and/or alkali-soluble group; and an optional compound (B) having at least one ethylenic unsaturated monomer and/or a radiation radical polymerization initiator (C). Also, the resin composition of the present invention may optionally contain an acrylic adhesive (G) and a thermal-polymerization initiator (H) along with or instead of the radiation radical polymerization initiator (C). Furthermore, the resin composition of the present invention may further contain a gelling agent (J), an emulsifying agent (K), a remover (L), or a thixotropy-imparting agent (I).

### <Polybutadiene Resin (A)>

The polybutadiene resin serving as component (A) employed in the present invention (hereinafter may also be referred to as resin (A)) is a reaction product of the polyol (a1) selected from among a polybutadiene polyol, a hydrogenated polybutadiene polyol, a polyisoprene polyol, and a hydrogenated polyisoprene polyol, with the cross-linking agent (a2). More specifically, the polybutadiene resin refers to a polybutadiene-based polyester resin formed through ester bonding of the cross-linking agent (a2) which is a polycarboxylic acid (a2-1) and/or a polyacid chloride (a2-2) linked to the polyol (a1), or a polybutadiene-based polyurethane resin formed through urethane bonding of the cross-linking agent (a2) which is a polyisocyanate (a2-3) linked to the polyol (a1). Alternatively, if needed, a part of the polyol (a1) may be substituted by a (meth)acrylate (b) having a substituent selected from a halogen, an isocyante group, and a hydroxy group and/or by a monool or polyol (c) having an alkali-soluble group (e.g., a carboxylic group), and may be reacted with the cross-linking agent (a2).

Next will be described the components forming the resin (A).

<Polyol (a1)>

The polyol (a1) employed in the present invention, selected from a polybutadiene polyol, a hydrogenated polybutadiene polyol, a polyisoprene polyol, and a hydrogenated polyisoprene polyol encompasses a hydrogenated product in which an unsaturated bond thereof is hydrogenated. Examples of such polyol include a polyethylene-based polyol, a polypropylene-based polyol, a polybutadiene-based polyol, a hydrogenated polybutadiene polyol, a polyisoprene polyol, and a hydrogenated polyisoprene polyol.

The polybutadiene polyol is more preferably a polybutadiene polyol which has a 1,4-bond type polybutadiene structure, a 1,2-bond type polybutadiene structure, or a mixture thereof, and two hydroxy groups, with a polybutadiene polyol having a hydroxy group at each chain end of the linear-chain polybutadiene structure.

The aforementioned polyol may be used singly or in combination of two or more species.

No particular limitation is imposed on the polybutadiene polyol, and examples include conventionally known general products. Specific examples include liquid polybutadiene having a hydroxy group at each terminal (e.g., NISSO PB (G series, products of Nippon Soda Co. Ltd.), or poly-Pd, product of Idemitsu Kosan, Co., Ltd.); a hydrogenated polybutadiene having a hydroxy group at each terminal thereof (e.g., NISSO PB (GI series, products of Nippon Soda Co. Ltd.), or Polytail H or HA, products of Mitsubishi Chemical Co., Ltd.); a liquid C5 polymer (e.g., Poly-iP, product of Idemitsu Kosan, Co., Ltd.); and a hydrogenated polyisoprene having a hydroxy group at each terminal (e.g., Epol, product of Idemitsu Kosan, Co., Ltd., or TH-1, TH-2, and TH-3, products of Kuraray Co., Ltd.). These products may be a commercial product or an ex-commercial product.

Among these polyols, hydrogenated polybutadiene polyols are preferably used from the viewpoints of hydrofluoric acid barrier property and film strength.

No particular limitation is imposed on the weight average molecular weight of the polyol. However, the lower limit of the molecular weight is preferably 300 or higher, from the viewpoint of enhancement in acid resistance of the formed resin thin film, more preferably 500 or higher, still more preferably 1,000 or higher. The upper limit of the molecular weight is preferably 30,000 or lower, more preferably 15,000 or lower, still more preferably 6,000 or lower, yet more preferably 3,000 or lower, for the purposes of suppression of an excessive increase in viscosity of the resin composition and maintenance of operability of the composition.

The iodine value of the polyol is suitably 0 to 50, preferably 0 to 20, and a hydroxy value thereof is suitably 15 to 400 mgKOH/g, preferably 30 to 250 mgKOH/g.

<Polycarboxylic Acid (a2-1)>

No particular limitation is imposed on the polycarboxylic acid (a2-1), and aromatic, aliphatic, alicyclic, and other polycarboxylic acids may be employed. Specific examples include aromatic polycarboxylic acids such as phthalic acid, 3,4-dimethylphthalic acid, isophthalic acid, terephthalic acid, pyromellitic acid, trimellitic acid, 1,4,5,8-naphthalenetetracarboxylic acid, and 3,3′,4,4′-benzophenonetetracarboxylic acid; aliphatic polycarboxylic acids such as succinic acid, glutaric acid, adipic acid, 1,2,3,4-butanetetracarboxylic acid, maleic acid, fumaric acid, and itaconic acid; and alicyclic polycarboxylic acids such as hexahydrophthalic acid, 3,4-dimethyltetrahydrophthalic acid, hexahydroisophthalic acid, hexahydroterephthalic acid, 1,2,4-cyclopentanetricarboxylic acid, 1,2,4-cyclohexanetricarboxylic acid, cyclopentanetetracarboxylic acid, and 1,2,4,5-cyclohexanetetracarboxylic acid.

Among the above polycarboxylic acids, aromatic and alicyclic polycarboxylic acids are particularly preferably used from the viewpoints of hydrofluoric acid barrier property and film strength.

These polycarboxylic acids may be used singly or in combination of two or more species.

<Polyacid Chloride (a2-2)>

No particular limitation is imposed on the polyacid chloride (a2-2), and aromatic, aliphatic, alicyclic, and other polyacid chlorides may be employed. Specific examples include aromatic polyacid chlorides such as phthalic acid dichloride, 3,4-dimethylphthalic acid dichloride, isophthalic acid dichloride, terephthalic acid dichloride, pyromellitic acid dichloride, trimellitic acid dichloride, 1,4,5,8-naphthalenetetracarboxylic acid tetrachloride, and 3,3′,4,4′-benzophenonetetracarboxylic acid tetrachloride; aliphatic polyacid chlorides such as succinic acid dichloride, glutaric acid dichloride, adipic acid dichloride, 1,2,3,4-butanetetracarboxylic acid tetrachloride, maleic acid dichloride, fumaric acid dichloride, and itaconic acid dichloride; and alicyclic polyacid chlorides such as hexahydrophthalic acid dichloride, hexahydroterephthalic acid dichloride, and cyclopentanetetracarboxylic acid tetrachloride.

Among the above polyacid chlorides, aromatic and alicyclic polyacid chlorides are particularly preferably used from the viewpoints of hydrofluoric acid barrier property and film strength. These polyacid chlorides may be used singly or in combination of two or more species.

<Polyisocyanate (a2-3)>

No particular limitation is imposed on the polyisocyanate (a2-3) employed in the present invention, and examples thereof include aromatic, aliphatic, and alicyclic polyisocyanates. Among them, suitably used are diisocyanates including tolylene diisocyanate, diphenylmethane diisocyanate, hydrogenated dipehnylmethane diisocyanate, modified diphenylmethane diisocyanate, hydrogenated xylylene diisocyanate, xylylene diisocyanate, hexamethylene diisocyanate, trimethylhexamethylene diisocyanate, tetramethylxylylene diisocyanate, isophorone diisocyanate, norbornene diisocyanate, and 1,3-bis(isocyanatomethyl)cyclohexane; trimers thereof; and biuret-type polyisocyanates thereof.

The molecular weight of the polyisocyanate (a2-3) is preferably 150 to 700 from the viewpoint of reactivity to a hydroxy group.

These polyisocyanates may be used singly or in combination of two or more species.

A characteristic feature of the resin (A) of the present invention resides in that the polybutadiene polyol (a1) is linked to the cross-linking agent (a2) via an ester bond or a urethane bond. The mode of the bond may be chosen in accordance with the purpose of use. From the viewpoints of film strength and adhesion to the substrate, a urethane bond is preferred, since the hydrogen bond strength of the urethane bond is higher than that of the ester bond, whereby excellent intermolecular affinity and affinity to the substrate can be attained.

### <Production of Resin (A)>

Resin (A) can be produced through reaction of polyol (a1) with polycarboxylic acid (a2-1), polyacid chloride (a2-2), or polyisocyanate (a2-3). When an ester bond is to be formed, the polyol is reacted with polycarboxylic acid (a2-1) or polyacid chloride (a2-2), whereas when a urethane bond is to be formed, the polyol is reacted with polyisocyanate (a2-3).

The reaction is preferably carried out in a solvent. No particular limitation is imposed on the solvent, so long as it is inert to the reaction. Examples include hydrocarbons such as hexane, cyclohexane, benzene, and toluene; halo-hydrocarbons such as tetrachlorocarbon, chloroform, and 1,2-dichloroethane; ethers such as diethyl ether, diisopropyl ether, 1,4-dioxane, and tetrahydrofuran; ketones such as acetone, methyl ethyl ketone, methyl isobutyl ketone, and cyclohexanone; nitriles such as acetonitrile and propionitrile; carboxylate esters such as ethyl acetate and ethyl propionate; azo aprotic polar solvents such as N,N-dimethylformamide, N,N-dimethylacetamide, N-methyl-2-pyrrolidone, and 1,3-dimethyl-2-imidazolidinone; and sulfo aprotic polar solvents such as dimethylsulfoxide and sulfolane. These solvents may be used singly or in combination of two or more species. Among them, toluene, cyclohexanone, etc. are preferred.

No particular limitation is imposed on the amount of the solvent used (concentration at reaction). The solvent may be used at a factor of 0.1 to 100 by mass, with respect to polyol (a1), preferably 1 to 10 by mass, more preferably 2 to 5 by mass.

No particular limitation is imposed on the reaction temperature. In the case where a urethane bond is formed in the reaction, the reaction temperature is preferably 30 to 90° C., particularly preferably 40 to 80° C.

In the case where an ester bond is formed in the reaction, the reaction temperature is preferably 30 to 150° C., particularly preferably 80 to 150° C.

The reaction time is generally 0.05 to 200 hours, preferably 0.5 to 100 hours.

The aforementioned reactions are preferably performed in the presence of a catalyst for promoting the reactions. Examples of the catalyst include organometallic compounds such as dibutyltin dilaurate, trimethyltin hydroxide, and tetra-n-butyltin; metal salts such as zinc octoate, tin octoate, cobalt naphthenate, stannous chloride, and stannic chloride; and amines such as pyridine, triethylamine, benzyldiethylamine, 1,4-diazabicyclo[2.2.2]octane, 1,8-diazabicyclo[5.4.0]-7-undecene, 1,5-diazabicyclo[4.3.0]-5-nonane, N,N,N′,N′-tetramethyl-1,3-butanediamine, and N-ethylmorpholine. Among them, dibutyltin dilaurate is preferred for forming a urethane bond, and pyridine and 1,8-diazabicyclo[5.4.0]-7-undecene are preferred for forming an ester bond.

No particular limitation is imposed on the amount of the catalyst when used. The catalyst amount is 0.00001 to 5 parts by mass, preferably 0.001 to 0.1 parts by mass, with respect to 100 parts by mass of polyol (a1).

Into the resin (A) of the present invention, a (meth)acrylate group may be incorporated in order to impart radiation curability to the resin. No particular limitation is imposed on the method of incorporating a (meth)acrylate group. Specifically, a (meth)acrylate group may be incorporated into the resin (A) by adding a (meth)acrylate (b) selected from among a halide (e.g., 2-chloroethyl acrylate), an isocyanate compound (e.g., 2-isocyanatoethyl acrylate), and a hydroxy group-containing compound (e.g., hydroxyethyl acrylate) to the reaction system involving polyol (a1) and polycarboxylic acid (a2-1), polyacid chloride (a2-2), or polyisocyanate (a2-3).

These (meth)acrylate compounds may be used singly and/or in combination. Of these, a hydroxy group-containing (meth)acrylate compound is preferred, since the raw material thereof is readily available.

No particular limitation is imposed on the halo-containing (meth)acrylate, and examples thereof include 2-chloroethyl (meth)acrylate, 2-chloropropyl (meth)acrylate, 2-chlorobutyl (meth)acrylate, 2-chloroethylacryloyl phosphate, 4-chlorobutyl (meth)acrylate, 2-(meth)acryloyloxyethyl-2-chloropropyl phthalate, and 2-chloro-3-acryloyloxypropyl (meth)acrylate.

No particular limitation is imposed on the isocyanato-containing (meth)acrylate, and examples thereof include 2-isocyanatoethyl (meth)acrylate, 2-isocyanatopropyl (meth)acrylate, 2-isocyanatobutyl (meth)acrylate, 2-isocyanatoethylacryloyl phosphate, and 4-isocyanatobutyl (meth)acrylate.

No particular limitation is imposed on the hydroxy group-containing (meth)acrylate, and examples thereof include 2-hydroxyethyl (meth)acrylate, 2-hydroxypropyl (meth)acrylate, 2-hydroxybutyl (meth)acrylate, 2-hydroxyethylacryloyl phosphate, 4-hydroxybutyl (meth)acrylate, 2-(meth)acryloyloxyethyl-2-hydroxypropyl phthalate, glycerin di(meth)acrylate, 2-hydroxy-3-acryloyloxypropyl (meth)acrylate, caprolactone-modified 2-hydroxyethyl (meth)acrylate, pentaerythritol tri(meth)acrylate, dipentaerythritol penta(meth)acrylate, and caprolactone-modified 2-hydroxyethyl (meth)acrylate.

Among them, a hydroxy group-containing (meth)acrylate having a C2 to C20 alkyl group is useful, from the viewpoint of adhesion and weather resistance.

Into the resin (A) of the present invention, an alkali-soluble group may be incorporated in order to impart aqueous-alkali-developability and/or -peelability to the resin. Examples of the method of incorporating an alkali-soluble group into the resin (A) include a method in which the resin (A) is mixed with an alkali-soluble resin to form a composition, and a method in which an alkali-soluble group is incorporated into the resin via a chemical bond. From the viewpoint of solubility in an aqueous alkali solution, preferred is a method in which an alkali-soluble group is incorporated into the resin via a chemical bond.

Examples of the alkali-soluble group include an acidic group (e.g., a carboxy group), or an acid-releasing group (e.g., a t-butyl carboxylate ester group). These alkali-soluble groups may be used singly and/or in combination.

From the viewpoint of production of the resin (A) of the present invention, a monool or a polyol (c) having a carboxy group or a similar alkali-soluble group serving as the above alkali-soluble group is preferably used, since the raw material of such an alcoholic compound is readily available.

In one possible method of incorporating an alkali-soluble group into the resin (A), a monool or a polyol (c) having an alkali-soluble group is added to the reaction system involving polyol (a1) and polycarboxylic acid (a2-1), polyacid chloride (a2-2), or polyisocyanate (a2-3).

No particular limitation is imposed on the monool or polyol (c) having a carboxy group. Example of the monool having a carboxy group include hydroxyacetic acid, hydroxypropionic acid, hydroxybutanoic acid, 12-hydroxystearic acid, hydroxypivalic acid, 15-hydroxypentadecanoic acid, 16-hydroxyhexadecanoic acid, malic acid, and citric acid. Example of the polyol having a carboxy group include 2,2-bis(hydroxymethyl)butyric acid, tartaric acid, 2,4-dihydroxybenzoic acid, 3,5-dihydroxybenzoic acid, 2,2-bis(hydroxymethyl)propionic acid, 2,2-bis(hydroxyethyl)propionic acid, 2,2-bis(hydroxypropyl)propionic acid, dihydroxymethylacetic acid, bis(4-hydroxyphenyl)acetic acid, 4,4-bis(4-hydroxyphenyl)pentanoic acid, and homogentisic acid.

Among the above monools and polyols (c) having a carboxy group, 12-hydroxystearic acid and 2,2-bis(hydroxyethyl)propionic acid are particularly preferred by virtue of their adhesion performance.

In the specific examples of the monool or polyol (c) having a carboxy group, the members are given as a generally accepted trivial name (“ . . . acid”). However, each of these specific examples is a compound having a one or more COOH groups and one or more OH groups.

When a (meth)acrylate group and/or an alkali-soluble group are incorporated into the resin (A) of the present invention, any method may be employed. Examples of the method include a method (i) in which a polyol (a1), an optional monool or polyol (c) having a carboxy group, and an optional (meth)acrylate (b) are simultaneously fed into a polyisocyanate (a2-3), and the mixture is allowed to react; a method (ii) in which a polyisocyanate (a2-3), a polyol (a1), and an optional monool or polyol (c) having a carboxy group are reacted, and then further reacted with an optional (meth)acrylate (b); and a method (iii) in which a polyisocyanate (a2-3) is reacted with an optional (meth)acrylate (b), and the further reacted with an optional monool or polyol (c) having a carboxy group.

In one preferred method for incorporating a (meth)acrylate group and an alkali-soluble group into the resin (A) of the present invention, a polyol (a1) is reacted with a polyisocyanate (a2-3) at a reaction mole ratio of k:k+1 (mole ratio) (k is an integer of ≧1), to thereby yield an isocyanate group-containing compound [a], the isocyanate group-containing compound [a] is reacted with a monool or polyol (c) having a carboxy group at a reaction mole ratio of 1:1, and the reaction product is further reacted with a (meth)acrylate (b) at a reaction mole ratio of 1:1 to 1:10. In an alternatively preferred method, the isocyanate group-containing compound [a] is reacted with a (meth)acrylate (b) at a reaction mole ratio of 1:1, and the reaction product is reacted further with a monool or polyol (c) having a carboxy group at a reaction mole ratio of 1:1 to 1:10.

In the production of the aforementioned resin (A), when the produced resin (A) is to have high viscosity, the below-mentioned ethylenic unsaturated monomer (B) may be optionally fed in advance to a reaction pot, whereby the reaction components are reacted in the ethylenic unsaturated monomer (B).

Thus, the resin (A) employed in the present invention can be yielded. In the present invention, the resin (A) preferably has a weight average molecular weight of 5,000 to 400,000, more preferably 10,000 to 200,000. When the weight average molecular weight is lower than 5,000, the strength of the formed coating film is poor, whereas when the molecular weight is in excess of 400,000, solubility and coatability are impaired. Both cases are not preferred.

Notably, the above weight average molecular weight is a weight average molecular weight as reduced to the molecular weight of a standard polystyrene. The weight average molecular weight is determined through high-performance liquid chromatography (Shodex GPC system-11, product of Showa Denko K.K.) by use of serially connected three columns (Shodex GPC KF-806L (product of Showa Denko K.K., elimination limit molecule quantity: 2×10⁷, separation range: 100 to 2×10⁷, theoretical plate no.: 10,000 steps/column, filler material: styrene-divinylbenzene copolymer, and filler particle size: 10 μm).

The glass transition temperature of the resin (A) (as measured by TMA (thermomechanical analysis) is preferably 0° C. or higher. When the glass transition temperature is lower than 0° C., the resist surface has undesirable tack property.

Also in the present invention, one molecule of the resin (A) preferably has 1 to 3 ethylenic unsaturated groups. When the molecule has more than 3 ethylenic unsaturated groups, the adhesion of a coating film cured through active energy ray radiation decreases, and the hydrofluoric acid barrier property is impaired, which is not preferred.

Commercial products of the thus-produced resin (A) may also be employed. Examples of such commercial products include UC-203 (product of Kuraray Co., Ltd.) and UV-3610ID80, UV-3630ID80, UV-3635ID80 (products of The Nippon Synthetic Chemical Industry Co., Ltd.).

### <(B) Ethylenic Unsaturated Monomer>

In order to improve adhesion performance and coatability, the resin composition of the present invention may further contain an ethylenic unsaturated monomer (B), which is a compound having at least one ethylenic unsaturated double bond. No particular limitation is imposed on the ethylenic unsaturated monomer (B), and examples thereof include a mono-function (meth)acrylate, a bi-function (meth)acrylate, and ≧3-function (meth)acrylate. Of these, a mono-function (meth)acrylate is effectively used from the viewpoint of adhesion, with C≧6 aliphatic or alicyclic alkyl (meth)acrylates being particularly preferred.

Examples of the C≧6 aliphatic or alicyclic alkyl (meth)acrylate include hexyl (meth)acrylate, 2-ethylhexyl (meth)acrylate, heptyl (meth)acrylate, octyl (meth)acrylate, isooctyl (meth)acrylate, nonyl (meth)acrylate, isononyl (meth)acrylate, decyl (meth)acrylate, isodecyl (meth)acrylate, dodecyl (meth)acrylate, stearyl (meth)acrylate, isostearyl (meth)acrylate, lauryl (meth)acrylate, cyclohexyl (meth)acrylate, isobornyl (meth)acrylate, isoamyl (meth)acrylate, dicyclopentenyl (meth)acrylate, and tricyclodecanyl (meth)acrylate. Of these, isodecyl (meth)acrylate, lauryl (meth)acrylate, cyclohexyl (meth)acrylate, isostearyl (meth)acrylate, and 2-ethylhexyl (meth)acrylate are preferably used.

Examples of mono-function (meth)acrylates other than the C≧6 aliphatic or alicyclic alkyl (meth)acrylate include methyl (meth)acrylate, ethyl (meth)acrylate, phenoxyethyl (meth)acrylate, glycerin mono(meth)acrylate, glycidyl (meth)acrylate, n-butyl (meth)acrylate, benzyl (meth)acrylate, ethylene oxide-modified (n=2) phenol (meth)acrylate, propylene oxide-modified (n=2.5) nonylphenol (meth)acrylate, 2-(meth)acryloyloxyethyl acid phosphate, furfuryl (meth)acrylate, carbitol (meth)acrylate, benzyl (meth)acrylate, butoxyethyl (meth)acrylate, allyl (meth)acrylate, 2-hydroxyethyl (meth)acrylate, 2-hydroxypropyl (meth)acrylate, 2-hydroxybutyl (meth)acrylate, 2-phenoxy-2-hydroxypropyl (meth)acrylate, 2-hydroxy-3-phenoxypropyl (meth)acrylate, and 3-chloro-2-hydroxypropyl (meth)acrylate.

Among them, a hydroxy group-free mono-function (meth)acrylate is preferred, with such an acrylate having a molecular weight of about 100 to about 300 being more preferred.

Examples of the bi-function (meth)acrylate include ethylene glycol di(meth)acrylate, diethylene glycol di(meth)acrylate, tetraethylene glycol di(meth)acrylate, polyethylene glycol di(meth)acrylate, propylene glycol di(meth)acrylate, dipropylene glycol di(meth)acrylate, polypropylene glycol di(meth)acrylate, butylene glycol di(meth)acrylate, neopentyl glycol di(meth)acrylate, ethylene oxide-modified bisphenol A di(meth)acrylate, propylene oxide-modified bisphenol A di(meth)acrylate, 1,6-hexanediol di(meth)acrylate, glycerin di(meth)acrylate, pentaerythritol di(meth)acrylate, ethylene glycol diglycidyl ether di(meth)acrylate, diethylene glycol diglycidyl ether di(meth)acrylate, phthalic acid diglycidyl ester di(meth)acrylate, and hydroxypyvalic acid-modified neopentyl glycol di(meth)acrylate.

Examples of the ≧3-function (meth)acrylate include trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, tri(meth)acryloyloxyethoxytrimethylolpropane, and glycerin polyglycidyl ether poly(meth)acrylate.

These ethylenic unsaturated monomers (B) may be used singly or in combination of two or more species.

In the present invention, the ratio (A):(B) of the amount of the above urethane (meth)acrylate resin (A) to the amount of the ethylenic unsaturated monomer (B) is preferably 2:98 to 95:5 (by mass), more preferably 50:50 to 80:20 (by mass). When the resin (A) content is lower than the above lower limit, adhesion is poor, whereas when the resin content is in excess of the upper limit, coatability is impaired. Both cases are not practically preferred.

### <(C) Photo-Polymerization Initiator (Radiation Radical Polymerization Initiator)>

Examples of the radiation radical polymerization initiator (C) employed in the present invention include α-diketones such as diacetyl; acyloins such as benzoin; acyloin ethers such as benzoin methyl ether, benzoin ethyl ether, and benzoin isopropyl ether; benzophenones such as thioxanthone, 2,4-diethylthioxanthone, thioxanthone-4-sulfonic acid, benzophenone, 4,4′-bis(dimethylamino)benzophenone, and 4,4′-bis(diethylamino)benzophenone; acetophenones such as acetophenone, p-dimethylaminoacetophenone, α,α-dimethoxy-α-acetoxyacetophenone, α,α-dimethoxy-α-phenylacetophenone, p-methoxyacetophenone, 1-[2-methyl-4-methylthiophenyl]-2-morpholino-1-propanone, α,α-dimethoxy-α-morpholino-methylthiophenylacetophenone, and 2-benzyl-2-dimethylamino-1-(4-morpholinophenyl)butan-1-one; quinones such as anthraquinone and 1,4-naphthoquinone; halogen compounds such as phenacyl chloride, tribromomethyl phenyl sulfone, and tris(trichloromethyl)-s-triazine; bisimidazoles such as [1,2′-bisimidazole]-3,3′,4,4′-tetraphenyl and [1,2′-bisimidazole]-1,2′-dichlorophenyl-3,3′,4,4′-tetraphenyl; peroxides such as di-tert-butyl peroxide; and acylphosphine oxides such as 2,4,6-trimethylbenzoyldiphenylphosphine oxide.

Commercial products of the radiation radical polymerization initiator include Irgacur 127, 184, 369, 379EG, 651, 500, 907, CGI369, and CG24-61, Lucirin LR8728 and TPO, and Darocure 1116 and 1173 (trade names, products of BASF), and Ubecryl P36 (trade name, product of UCB).

Among them, preferred are acetophenones such as 1-[2-methyl-4-methylthiophenyl]-2-morphilono-1-propanone, 2-benzyl-2-dimethylamino-1-(4-morpholinophenyl)butan-1-one, and α,α-dimethoxy-α-phenylacetophenone; phenacyl chloride; tribromomethyl phenyl sulfone; 2,4,6-trimethylbenzoyldiphenylphosphine oxide; a combination of a 1,2′-bisimidazole, 4,4′-diethylaminobenzophenone, and mercaptobenzothiazol; Lucirin TPO (trade name); Irgacur 651 (trade name); Irgacur 369 (trade name); and Darocure 1173 (trade name).

The aforementioned radiation radical polymerization initiators (C) may be used singly or in combination of two or more species. The aforementioned radiation radical polymerization initiator (C) is preferably used in an amount, with respect to 100 parts by mass of the above resin (A), 0.1 to 50 parts by mass, more preferably 1 to 30 parts by mass, particularly preferably 2 to 30 parts by mass. When the amount of the radiation radical polymerization initiator (C) is smaller than the lower limit of the above range, radicals are readily deactivated by oxygen (reduction in sensitivity), whereas when the amount is greater than the upper limit of the range, compatibility and storage stability tend to decrease.

In the composition of the present invention, if needed, the radiation radical polymerization initiator (C) may be used in combination with a hydrogen-donor compound such as mercaptobenzothiazole and mercaptobenzoxazole or a radiation sensitizer.

### <(H) Thermal Radical Polymerization Initiator>

Examples of the thermal radical polymerization initiator (H) of the present invention include a hydrogen peroxide, an azo compound, and a redox-type initiator.

Examples of the hydrogen peroxide include t-butyl(3,5,5-trimethylhexanoyl) peroxide, t-butyl hydroperoxide, cumene hydroperoxide, t-butyl peroxyacetate, t-butyl peroxybenzoate, t-butyl peroxyoctanoate, t-butyl peroxyneodecanoate, t-butyl peroxyisobutyrate, lauroyl peroxide, t-amyl peroxyvivalate, t-butyl peroxypivalate, dicummyl peroxide, benzoyl peroxide, potassium persulfate, and ammonium persulfate.

Examples of the azo compound include dimethyl 2,2′-azobis(2-methylpropionate), 2,2′-azobis(isobutyronitrile), 2,2′-azobis(2-butanenitrile), 4,4′-azobis(4-pentanoic acid), 1,1′-azobis(cyclohexanecarbonitrile), 2-(t-butylazo)-2-cyanopropane, 2,2′-azobis[2-methyl-N-(1,1)-bis(hydroxymethyl)-2-hydroxyethyl]propionamide, 2,2′-azobis(2-methyl-N-hydroxyethyl)propionamide, 2,2′-azobis(N,N′-dimethyleneisobutylamidine) dichloride, 2,2′-azobis(2-amidinopropane) dichloride, 2,2′-azobis(N,N-dimethyleneisobutylamide), 2,2′-azobis(2-methyl-N-[1,1-bis(hydroxymethyl)-2-hydroxyethyl]propionamide), 2,2′-azobis(2-methyl-N-[1,1-bis(hydroxymethyl)ethyl]propionamide), 2,2′-azobis[2-methyl-N-(2-hydroxyethyl)propionamide), and 2,2′-azobis(isobutylamide) dihydrate.

Examples of the redox-type initiator include a mixture of a peroxide (e.g., hydrogen peroxide, an alkyl peroxide, a peracid ester, or a percarbonate salt) and an iron salt, a titanous salt, a zinc formaldehyde sulfoxylate, a sodium formaldehyde sulfoxylate, or a reducing sugar. Examples further include a mixture of an alkali metal salt of a persulfuric acid, a perboric acid, or a perchloric acid, ammonium perchlorate, with an alkali metal bisulfite such as sodium metabisulfite or a reducing sugar. Examples further include a mixture of an alkali metal persulfate with an arylsulfonic acid such as benzenesufonic acid, a reducing sugar, or the like.

Commercial products of the thermal radial polymerization initiator (H) which may be employed in the present invention include Perhexa HC (product of NOF Corporation) and MAIB (product of Tokyo Chemical Industry Co., Ltd.).

The aforementioned thermal radical polymerization initiators (H) may be used singly or in combination of two or more species. The aforementioned thermal radical polymerization initiator (H) is preferably used in an amount, with respect to 100 parts by mass of the above resin (A), 0.1 to 50 parts by mass, more preferably 1 to 30 parts by mass, particularly preferably 2 to 30 parts by mass. When the amount of the thermal radical polymerization initiator (H) is smaller than the lower limit of the above range, radicals are readily deactivated by oxygen (reduction in sensitivity), whereas when the amount is greater than the upper limit of the range, compatibility and storage stability tend to decrease.

The aforementioned radiation radical polymerization initiator (C) and thermal radical polymerization initiator (H) may be used individually or in combination for enhancing the curability of the resin composition. In one possible mode, only a UV-exposed portion of the pattern is cured in the presence of a radiation radical polymerization initiator, and after development, unreacted ethylenic unsaturated double bonds in the cured product are reacted by use of a thermal radical polymerization initiator.

### <Other Components>

In addition to the aforementioned resin (A), and an optional compound having at least one ethylenic unsaturated double bond (B) and/or the radiation radical polymerization initiator (C), the resin composition of the present invention may further contain the aforementioned thermal-polymerization initiator (H) with or instead of the radiation radical polymerization inhibitor (C). Also, the resin composition of the present invention may further contain optional additives such as a surfactant (D), a thermal polymerization inhibitor (E), an acid anhydride (F), an acrylic adhesive (G), a gelling agent (J), an emulsifying agent (K), a remover (L), and a thixotropy-imparting agent (I), and other components such as a solvent.

### <(D) Surfactant>

In order to enhance coatability, defoaming property, leveling property, and other properties, a surfactant (D) may be added to the resin composition of the present invention.

Examples of the surfactant (D) which may be used in the present invention include commercial fluorine-containing surfactants and silicone surfactants such as BM-1000 and BM-1100 (products of BM Chemie), Megafac F142D, F172, F173, F183, and F570 (products of DIC); Fluorad FC-135, FC-170C, FC-430, and FC-431 (products of Sumitomo 3M Ltd.); Surflon S-112, S-113, S-131, S-141, and S-145 (products of Asahi Glass Co., Ltd.); and SH-28PA, -190, -193, SZ-6032, and SF-8428 (products of Toray Dow Corning Silicone).

Any of the surfactants is preferably used in an amount of 5 parts by mass or lower, with respect to 100 parts by mass of the resin (A).

### <(E) Thermal Polymerization Inhibitor>

To the resin composition of the present invention, a thermal polymerization inhibitor (E) may be added. Examples of the thermal polymerization inhibitor include pyrogallol, benzoquinone, hydroquinone, methylene blue, tert-butylcatechol, monobenzyl ether, methylhydroquinone, amylquinone, amyloxyhydroquinone, n-butylphenol, phenol, hydroquinone monopropyl ether, 4,4′-(1-methylethylidene)bis(2-methylphenol), 4,4′-(1-methylethylidene)bis(2,6-dimethylphenol), 4,4′-[1-[4-(1-(4-hydroxyphenyl)-1-methylethyl)phenyl]ethylidene]bisphenol, 4,4′,4″-ethylidenetris(2-methylphenol), 4,4′,4″-ethylidenetrisphenol, and 1,1,3-tris(2,5-dimethyl-4-hydroxyphenyl)-3-phenylpropane.

The thermal polymerization inhibitor is preferably used in an amount of 5 parts by mass or lower, with respect to 100 parts by mass of the resin (A).

### <(F) Acid or Acid Anhydride>

For the purpose of fine tuning of the solubility of the resin composition of the present invention in an alkali developer, an acid or an acid anhydride may be added to the resin composition. Examples of the acid and acid anhydride include monocarboxylic acids such as acetic acid, propionic acid, n-butyric acid, isobutyric acid, n-valeric acid, isovaleric acid, benzoic acid, and cinnamic acid; hydroxymonocarboxylic acids such as lactic acid, 2-hydroxybutyric acid, 3-hydroxybutyric acid, salicylic acid, m-hydroxybenzoic acid, p-hydroxybenzoic acid, 2-hydroxycinnamic acid, 3-hydroxycinnamic acid, 4-hydroxycinnamic acid, 5-hydroxyisophthalic acid, and syringic acid; polycarboxylic acids such as oxalic acid, succinic acid, glutaric acid, adipic acid, maleic acid, itaconic acid, hexahydrophthalic acid, phthalic acid, isophthalic acid, terephthalic acid, 1,2-cyclohexanedicarboxylic acid, 1,2,4-cyclohexanetricarboxyliic acid, trimellitic acid, pyromellitic acid, cyclopentanetetracarboxylic acid, butanetetracarboxylic acid, and 1,2,5,8-naphthalenetetracarboxylic acid; acid anhydrides such as itaconic anhydride, succinic anhydride, citraconic anhydride, dodecenylsuccinic anhydride, tricarbanilic anhydride, maleic anhydride, hexahydrophthalic anhydride, methyltetrahydrophthalic anhydride, hymic anhydride, 1,2,3,4-butanetetracarboxlic dianhydride, cyclopentanetetracarboxlic dianhydride, phthalic anhydride, pyromellitic anhydride, trimellitic anhydride, benzophenonetetracarboxylic anhydride, ethylene glycol bistrimellitate anhydride, and glycerin tristrimellitate anhyderide.

### <Solvent>

The solvent employed in the present invention can uniformly dissolve the resin (A) and other components and does not react with the components. The same polymerization solvents as employed in production of the aforementioned urethane (meth)acrylate resin (A) may be used as the solvent. Furthermore, an additional high-boiling point solvent may be added. Examples of the high-boiling point solvent include N-methylformamide, N,N-dimethylformamide, N-methylformanilide, N-methylacetamide, N,N-dimethylacetamide, N-methylpyrrolidone, dimethylsulfoxide, benzyl ethyl ether, dihexyl ether, acetonylacetone, isophorone, caproic acid, caprylic acid, 1-octanol, 1-nonanol, benzyl alcohol, benzyl acetate, ethyl benzoate, diethyl oxalate, diethyl maleate, γ-butyrolactone, ethylene carbonate, propylene carbonate, and phenyl cellosolve acetate.

Among these solvents, from the viewpoints of solubility, reactivity to the components, and ease of forming coating film, preferred are polyol alkyl ethers such as ethylene glycol monoethyl ether and diethylene glycol monomethyl ether; polyol alkyl ether acetates such as ethylene glycol ethyl ether acetate and propylene glycol monomethyl ether acetate; esters such as ethyl 3-ethoxypropionate, methyl 3-methoxypropionate, ethyl 2-hydroxypropionate, and ethyl lactate; and ketones such as diacetone alcohol. The amount of the solvent may be predetermined in accordance with the purpose of use of the composition, the coating method, and other factors.

### <(G) Acrylic Adhesive>

For enhancing the adhesion property, coatability, and peeling property of the resin composition of the present invention, the resin composition may further contain an acrylic adhesive (G). No particular limitation is imposed on the acrylic adhesive, and generally employed acrylic adhesives may be used. Examples of the acrylic adhesive include poly(acrylic acid), poly(ethyl acrylate), poly(butyl acrylate), poly(propyl acrylate), and poly(methyl acrylate).

The acrylic adhesive which may be used in the present invention is, for example, an acrylic adhesive which is formed of a predominant monomer component for providing tackiness, a comonomer component for attaining adhesion and cohesion, and a polymer or copolymer predominantly formed of a functional-group-containing monomer component for improving cross-linking points and adhesion. By use of the acrylic adhesive with the resin (A), the tackiness and coatability of the resin composition can be enhanced. In addition, the resin composition can be provided with toughness, whereby the peeling removal property can be enhanced while excellent adhesion to the substrate is maintained.

From the viewpoint of acid resistance, the acrylic adhesive is preferably formed mainly from a low-polarity (meth)acrylate as a monomer component. An aliphatic or alicyclic mono-function or poly-function monomer is suitably employed.

Examples of the aliphatic mono-function or poly-function monomer include isononyl (meth)acrylate, isodecyl (meth)acrylate, isoundecyl (meth)acrylate, isododecyl (meth)acrylate, 1,3-butylene glycol di(meth)acrylate, 1,4-butanediol di(meth)acrylate, neopentyl glycol di(meth)acrylate, hydroxypyvalic acid neopentyl glycol di(meth)acrylate, and 1,6-hexanediol di(meth)acrylate.

Examples of the mono-function or poly-function monomer having an alicyclic structure include cyclopentanyl (meth)acrylate, dicyclopentanyl (meth)acrylate, and dicyclopentanyl di(meth)acrylate.

Through preparing an acrylic adhesive from such a low-polarity monomer; i.e., a hydrophobic monomer, the adhesive has excellent compatibility to a hydrophobic polyester resin and/or polyurethane resin produced from, for example, polybutadiene polyol.

In the production of the acrylic adhesive from a polymer or a copolymer of the monomer component(s), predominant monomers forming the acrylic structure may be used singly or in combination of two or more species.

Examples of commercial products of the acrylic adhesive (G) which may be used in the present invention include SR395 (product of Sartomer); FA-513M, FA-511AS, and FA-513AS (products of Hitachi Chemical Co., Ltd.); and DPHA (product of Nippon Kayaku Co., Ltd.).

In the resin composition of the present invention, no particular limitation is imposed on the amount of the resin (A) added to the resin composition, but the amount is preferably 1 part by mass or greater, more preferably 2 parts by mass or greater, with respect to the total solid content. The amount may be increased to 5 parts by mass or greater. When the amount of the resin (A) is smaller than the above range, sufficient acid resistance cannot be attained, and the resist readily dissolves or peels during etching. The amount has no upper limit. If the amount is 100 parts by mass, the aforementioned excellent acid resistance can be attained. In other words, through adjusting the amount of the resin (A) to fall within the aforementioned range, there can be yielded a resin composition having a more excellent hydrofluoric acid barrier property, substrate adhesion, and peeling removal property. On the other hand, when the amount of the resin (A) added to the resin composition increases, the resulting composition may have high viscosity. In order to avoid limitation on the coating method and attain favorable coatability, the viscosity of the composition may be reduced by diluting the composition with organic solvent or a monomer for forming the acrylic adhesive.

The relative amount of the acrylic adhesive to the resin (A) is preferably 50 to 3,300 parts by mass, with respect to 100 parts by mass of the resin (A), more preferably 100 to 3,000 parts by mass, still more preferably 130 to 2,600 parts by mass. When the amount (relative to the acrylic adhesive) of the resin (A) added to the resin composition is adjusted to fall within the aforementioned range, there can be yielded a resin composition having an excellent substrate adhesion, hydrofluoric acid barrier property, and peeling removal property.

In the present invention, controlling the peeling removal property of the resin composition is an important concept. Specifically, the acrylic adhesive exhibits excellent bonding (also called tackiness or adhesion) to the substrate immediately after application thereof, but the adhesive is degraded or dissolved when immersed in an etchant, whereby bonding to the substrate is readily reduced. On the other hand, since a polyester resin and/or polyurethane resin (A) produced from a polybutadiene polyol as a raw material has high acid resistance, the resin strongly adheres to the substrate even after etching. In other words, the resin is difficult to peel off from the substrate. Thus, by mixing the two components at an appropriate mixing ratio, the resin composition can strongly adhere to the substrate during etching, and the adhesion drops due to degradation of the resist film after etching, whereby the remaining film can be readily removed through peeling. The “appropriate mixing ratio” may be experimentally determined on the basis of various conditions including the acid concentration and temperature of the etchant, circulation of the etchant, etching time, and shaking of the substrate.

In the present invention, the acrylic adhesive may be polymerized on a substrate after application of a starting monomer on the substrate. In polymerization, a generally employed thermal-/photo-radical generator is suitably used as a polymerization initiator. So long as the effects of the present invention are not impaired, an inorganic filler, a leveling agent, or the like may be added to the adhesive.

### <(L) Remover>

In order to enhance the peeling removal property of the resin composition of the present invention, a remover (L) may be added to the resin composition.

The remover (L) which may be used in the present invention is preferably a wax-type compound, a silcone compound, a fluorine-containing compound, etc. Among them, silicone compounds (silicone oil having a siloxane skeleton, emulsion, etc.) are most suitable, by virtue of excellent heat resistance, moisture resistance, and stability over time in terms of peeling performance. Examples the remover (L) which may be used in the present invention include commercial silicone oils such as KF-96-10CS, KF-6012, X-22-2426, and X-22-164E (products of Shin-Etsu Silicones Co., Ltd.), TEGO RAD 2200N and TEGO RAD 2700 (products of Evonik), and BYK-333 (product of BYK Japan K.K.).

The amount of the remover added to the resin composition is preferably 5 parts by mass or less, with respect to 100 parts by mass of the resin (A).

### <(I) Thixotropy-Imparting Agent>

To the resin composition of the present invention, an inorganic filler such as fumed silica, a modified urea resin, or the like may be added, in order to impart thixotropic property to the resin composition, to thereby enhance coatability of the composition.

Examples of the thixotropy-imparting agent (I) which may be used in the present invention include commercial products of hydrophilic/hydrophobic fumed silica such as Aerosil 200, Aerosil RX200, and Aerosil RY200 (products of Nippon Aerosil Co., Ltd.), and commercial products of modified urea resins such as BYK-405, BYK-410, and BYK-411 (products of BYK Japan K.K.). These thixotropy-imparting agents (I) may be used singly or in combination of two or more species.

The thixotropy-imparting agent content is preferably 0.1 to 10 parts by mass, with respect to 100 parts by mass of the resin composition, more preferably 1 to 6 parts by mass. When the thixotropy-imparting agent content falls within the above range, coatability of the resin composition can be enhanced, while excellent hydrofluoric acid barrier property and adhesion to substrate are maintained.

As shown in the below-described Examples, the resin composition of the present invention has such a coatability that a coating film of the composition can be formed through screen printing or a similar technique, along with hydrofluoric acid barrier property and adhesion to substrate, through incorporation of a specific amount of the thixotropy-imparting agent.

### <(J) Gelling Agent>

To the resin composition of the present invention, there may be added a gelling agent such as hydroxystearic acid or a saccharide derivative, for enhancing the coatability of the composition through tuning of the viscosity.

Through elevating the resin (A) solid content of the resin composition, to thereby increase the amount of the resin (A) remaining after vaporization of the solvent, a resist film having a relatively large thickness can be readily formed. On the other hand, when the solid content is elevated, the viscosity of the composition increases, whereby coatability is impaired, to possibly cause problems such as coating failure. In the present invention, the gelling agent induces gelation at a gelling step (a prebake step) or another step after application of the resin composition, to thereby maintain a relatively thick resist film. Thus, incorporation of the gelling agent (J) can provide a resist which has high solid content but low viscosity and which is gelled at, for example, a prebake step before exposure to UV light, whereby the thickness of the resist film can be realized.

The resin composition containing such a gelling agent may be used in a resin composition for hydrofluoric acid etching, as well as for resin compositions for other uses such as ITO patterning resist, plating resist, and MEMS resist. However, according to the present invention, in which a gelling agent is incorporated into the resin composition for hydrofluoric acid etching, the resin composition exhibits, as shown in the below-described Examples, excellent hydrofluoric acid barrier property, as well as excellent peeling removal property, uniformity in film thickness, etc.

The gelling agent of the present invention induces gelation of the resin composition at room temperature. Any gelling agent may be used, so long as the galling agent imparts such a thermally reversible property to the resin composition that the thus-formed solid gel is heated to be transformed into a liquid (sol) with flowability, and the sol is returned to the gel again. The term gelation refers to such a phenomenon that a liquid loses flowability to form a solid which does not collapse by its own weight.

No particular limitation is imposed on the gelling agent (J), so long as it allows to the resin composition to be in a gel state, and any generally available oily gelling agent may be used. Examples of the oily gelling agent include an amino acid derivative, a long-chain fatty acid, a long-chain fatty acid polyvalent metal salt, a saccharide derivative, and a wax. Of these, an amino acid derivative and a long-chain fatty acid are particularly preferred, from the viewpoints of coatability and other factors. Upon incorporation, the gelling agent (J) may be in powder state or a solution dissolved in a conventional organic solvent such as ethanol or PGME (1-methoxy-2-propanol). Notably, ethanol and PGME inhibit formation of a hydrogen bond of a gelling agent in the resin composition, to thereby suppress gelation of the composition.

Specific examples of preferred amino acid derivatives include C2 to C 15 amino acids in which an amino group is acylated and C2 to C 15 amino acids in which a carboxy group is esterified or amidized. Examples thereof include di(cholesteryl/beheynl/octyldodecyl) N-lauroyl-L-glutamate, di(cholesteryl/octyldodecyl) N-lauroyl-L-glutamate, di(phitosteryl/behenyl/octyldodecyl) N-lauroyl-L-glutamate, di(phitosteryl/octyldodecyl) N-lauroyl-L-glutamate, N-lauroyl-L-glutamic dibutylamide, and N-ethylhexanoyl-L-glutamic dibutylamide. Of these, N-lauroyl-L-glutamic dibutylamide and N-ethylhexanoyl-L-glutamic dibutylamide are preferred from the viewpoint of coatability and other properties.

Specific examples of the long-chain fatty acid include C8 to C24 saturated or unsaturated fatty acids and homologous of the long-chain fatty acid, e.g., 12-hydroxystearic acid. Specific examples of the saturated fatty acid include octanoic acid, 2-ethylhexanoic acid, decanoic acid, lauric acid, myristic acid, stearic acid, palmitic acid, arachidic acid, and behenic acid. Specific examples of the unsaturated fatty acid include palmitoleinic acid, oleic acid, veccenic acid, linoleic acid, linolenic acid, arachdonic acid, icosadienic acid, and erucic acid.

Similar to the aforementioned long-chain fatty acids, specific examples of the long-chain fatty acid metal salt include metal salts of the aforementioned long-chain fatty acids. In the case of a C18 saturated fatty acid, specific examples include aluminum stearate, magnesium stearate, manganese stearate, iron stearate, cobalt stearate, calcium stearate, and lead stearate.

Specific examples of the saccharide derivative include fatty acid dextrin esters such as dextrin laurate, dextrin myristate, dextrin palmitate, dextrin margarate, dextrin stearate, dextrin arachate, dextrin lignocerate, dextrin cerotate, dextrin 2-ethylhexanoate palmitate, and dextrin palmitate stearate; fatty acid sucrose esters such as sucrose palmitate, sucrose stearate, and sucrose acetate/stearate; fatty acid oligofructose esters such as oligofructose stearate and oligofructose 2-ethylhexanoate; and sorbitol benzylidene derivatives such as monobenzylidene sorbitol and dibenzylidene sorbitol.

Among them, those having a melting point of 70 to 100° C.; e.g., 12-hydroxystearic acid (m.p.: 78° C.) and dextrin palmitate (m.p.: 85 to 90° C.), are preferred. The aforementioned gelling agents may be used singly or in combination of two or more species. The gelling agent of the present invention may be used as solid or may be dissolved in an organic solvent before use.

In the case where the gelling agent in solid form is added to the resin composition, the gelling agent is thermally melted at a prebake step (e.g., 80° C. to 110° C.) before exposure to UV light, and uniformly incorporated into the resin composition. After cooling, the composition becomes a gel. In the case where the gelling agent is added as a solution in an organic solvent, the organic solvent vaporizes at a prebake step, whereby the gelling agent concentration relatively increases. In another mechanism, the organic solvent, which impedes the interaction of the gelling agent, is removed, and the composition becomes a gel after cooling the composition. Needless to say, an optional post-bake step may be carried out.

By virtue of the gelling agent, the viscosity of the resin composition decreases at the prebake step, whereby the formed coating film has uniformity in thickness. Also, when cooled to room temperature after prebaking, the resin composition solidifies to form a gel, to thereby facilitate conveyance of the substrate, etc.

The gelling agent content is preferably 0.1 to 30 parts by mass, with respect to 100 parts by mass of the resin composition, more preferably 3 to 10 parts by mass. When the gelling agent content falls within the above range, the coatability of the resin composition can be enhanced, while hydrofluoric acid barrier property and adhesion to substrate are maintained.

As shown in the below-described in the Examples, the resin composition of the present invention attains such a coatability that a coating film of the composition can be formed through slitter coating, and such a coatability that a coating film of the composition can be formed through slitter coating or a similar technique, along with hydrofluoric acid barrier property and adhesion to substrate, through incorporation of a specific amount of the gelling agent.

### <(K) Emulsifying Agent>

In order to enhance compatibility of the resin composition with the gelling agent (J), the resin composition of the present invention may further contain an emulsifying agent (K). In the case where the gelling agent (J) in powder form is used, uniform dispersion of the gelling agent (J) in the resin composition is facilitated through incorporation of the emulsifying agent (K) into the resin composition. In the case where the solution of the gelling agent (J) in an organic solvent is used, incorporation of the emulsifying agent (K) facilitates to prevent separation of the gelling agent (J) from the resin composition.

Notably, the emulsifying agent (K) may be added to the resin composition containing no gelling agent (J). In this case, separation between monomers can be readily prevented. In addition, separation of a monomer from the organic solvent can be readily prevented.

The present inventor has conducted extensive studies on the method of incorporating the gelling agent (J) into the resin composition of the present invention, and has found that uniformity in thickness of the cured film of the composition can be drastically improved, and the hydrofluoric acid barrier property is enhanced, through incorporation of the emulsifying agent (K). Generally, an emulsifying agent and a surfactant are formed of a compound having almost the same structure, and therefore, the two components may be defined as the same agent. However, in the present invention, the surfactant (D) differs from the emulsifying agent (K), from the viewpoint of the action and effect. Thus, as shown in the below-described Examples, enhancement in uniformity in thickness of the cured film is not observed when the surfactant (D) is used.

Examples of the emulsifying agent (K) which may be used in the present invention include modified silicone oils such as KF-640, KF-6012, and KF-6017 (products of Shin-Etsu Silicones Co., Ltd.) and polyoxyethylene alkyl ethers such as Pegnol O-20, Pegnol 16A, and Pegnol L-9A (products of Toho Chemical Industry Co., Ltd.). Among them, a modified silicone oil is preferred, since it can be used as the remover (L). The performance of the emulsifying agent is represented by a parameter HLB (hydrophile-lipophile balance). In the case of a substance having no hydrophilic group, HLB is 0, whereas in the case of a substance having only a hydrophilic group but no oleophilic group, HLB is 20. That is, the emulsifying agent has an HLB of 0 to 20. A suitable HLB value may be appropriately predetermined depending on the type of the resin composition.

The amount of the above emulsifying agent is 5 parts by mass or less, with respect to 100 parts by mass of the above resin (A).

No precise mechanism of enhancing the uniformity of the film of the resin composition cured by the emulsifying agent (K) has been elucidated. However, since the transparency of the cured film is enhanced, it is estimated that the growth of the gelling agent structure in the cured product is impeded, whereby the gelling agent structure remains a relatively small structure. One known compound having such an action is a gelling inhibitor. However, there has been no report which confirms that the emulsifying agent can serve as a gelling inhibitor.

### <Preparation of Resin Composition>

For preparing the resin composition of the present invention, the aforementioned resin (A) is mixed with an optional (B), (C), and/or (H), and the aforementioned optional component (D) and other components including (I), (J), (L), and (K) are added to, for example, the component (G). The mixtures are stirred through a known technique. In one mode of stirring, required amounts of the raw materials are fed to an SUS preparation tank equipped with agitation paddles, and the mixture is stirred at room temperature to a uniform composition. If required, the resultant composition may be filtered through a mesh, a membrane filter, or the like.

Notably, a resin composition containing the thermal-polymerization initiator (H), the photo-polymerization initiator (C), and the thixotropy-imparting agent (I) may be prepared through the following procedure. Specifically, low-viscosity materials which readily receive a thixotropic property including the ethylenic unsaturated monomer (B) and a solvent are mixed with the thixotropy-imparting agent by means of a high-shear mixer such as a disper, to thereby prepare a gel having a strong thixotropic property. Then, materials including the resin (A), except for the thermal-polymerization initiator (H) and the photo-polymerization initiator (C), are added to the gel and uniformly dispersed in the gel by means of a high-shear mixer. Finally, the polymerization initiator(s) is(are) added thereto, and the mixture is kneaded by means of a low-speed mixer such as a triple roll mill, to thereby preparer a uniform mixture. Through this mixing procedure, a highly uniform composition can be produced, and decomposition of the polymerization initiator(s), which would otherwise be caused by heat generated in agitation by means of a high-shear mixer, can be avoided. No particular limitation is imposed on the method and timing of adding the gelling agent (J) to thereby prepare the resin composition further containing the gelling agent (J), so long as heating to impair the gel-formation property of the gelling agent (J) is prevented. Basically, such a resin composition can be prepared through the same procedure as employed above. Also, as shown in the below-described Examples, such a resin composition may be prepared by preparing a resin composition serving as a base resin and then adding the gelling agent (J) thereto.

No particular limitation is imposed on the method and timing of adding the remover (L) or the emulsifying agent (K) to thereby prepare the resin composition further containing the remover (L) or the emulsifying agent (K), so long as the functions of the remover (L) and the emulsifying agent (K) are not impaired. In one specific procedure, a polymerizable monomer(s), an organic gelling agent, and a photo-polymerization initiator are placed in a glass sample bottle or the like, and other components such as a remover and an emulsifying agent are added thereto. The sample bottle is capped and shaken for agitation, to thereby prepare a resin composition containing the remover (L) or the emulsifying agent (K).

As described above, commercial products of the resin (A) and other components may also be used. In an embodiment where a commercial product of resin (A) is added to the component (G), when the resin (A) in advance contains the components (B) to (D), other components, and the acrylic adhesive (G), the amount ratios by mass of the resin (A) and the component (G) may be modified, in consideration of the type and amounts of the components incorporated in advance. In preparation of such a resin composition, a compatible cross-linking agent or the like may be appropriately added for adjusting the viscosity of the composition.

### <Method for Producing Substrate Having an Etching Pattern>

The method of the present invention for producing a substrate having an etching pattern includes a step of forming a resist film by applying, onto a glass substrate, a substrate having an insulating film (e.g., SiO₂ or SiN), or a similar substrate, the aforementioned resin composition of the present invention, and a step of patterning, through etching with an etchant such as hydrofluoric acid. The steps of the method of the present invention for producing a substrate having an etching pattern will next be described in detail.

### (1) Formation of Resist Film

A resist film of interest can be formed by applying, onto a glass substrate or a substrate having an insulating film (e.g., SiO₂ or SiN), the resin composition of the present invention and heating to remove the solvent of the composition.

Examples of the method of applying the composition to the substrate which method may be employed in the present invention include spin coating, slit coating, roller coating, screen printing, and applicator coating.

The conditions under which the coating film of the resin composition of the present invention is dried vary depending on the type and amounts of the components contained in the composition, the coating film thickness, and other factors. Generally, the coating film is dried at 40 to 160° C., preferably 60 to 120° C., for about 3 to about 15 minutes. When the drying time is too short, adhesion of the coating film during development becomes poor, whereas when the drying time is too long, pattern resolution may be impaired due to undesired heat application.

The thickness of the coating film of the resin composition of the present invention is preferably 5 to 40 μm, more preferably 5 to 30 μm. Through controlling the thickness to fall within the range, the coating film thickness can be considerably reduced, while desired characteristics including hydrofluoric acid barrier property can be attained.

### (2) Exposure to Radiation

The thus-obtained coating film is exposed, via a photomask having a pattern of interest, to radiation, for example, UV radiation having a wavelength of 300 to 500 nm or visible light, whereby the exposed portion can be cured.

In the present invention, the radiation refers to a UV radiation, visible light, far-UV radiation, an X-ray, an electron beam, or the like. Examples of the light source which may be used in the present invention include a low-pressure mercury lamp, a high-pressure mercury lamp, an ultra-high-pressure mercury lamp, a metal halide lamp, and an argon gas laser.

The dose of radiation, which varies in accordance with the type and amount(s) of the component(s) in the composition, the thickness of coating film, and other factors, is 100 to 1,500 mJ/cm², when a high-pressure mercury lamp is used.

### (3) Development

In one development method after irradiation, an unneeded non-exposed portion is dissolved and removed by use of an aqueous alkaline solution or an organic solvent as a developer, to thereby selectively leave the exposed portion, whereby a cured film having a target pattern is produced. Examples of the alkaline developer which may be used in the present invention include aqueous alkali solutions such as sodium hydroxide, potassium hydroxide, sodium carbonate, sodium silicate, sodium metasilicate, aqueous ammonia, ethylamine, n-propylamine, diethylamine, di-n-propylamine, triethylamine, methyldiethylamine, dimethylethanolamine, triethanolamine, tetramethylammonium hydroxide, tetraethylammonium hydroxide, pyrrole, piperidine, 1,8-diazabicyclo[5.4.0]-7-undecene, and 1,5-diazabicyclo[4.3.0]-5-nonane.

To any of the aqueous alkali solutions, an appropriate amount of an aqueous organic solvent such as methanol or ethanol and/or a surfactant may be added, to thereby provide an alternative developer.

No particular limitation is imposed on the organic solvent-containing developer, so long as it can favorably dissolve the resin (A). Examples of such developer which may be used in the present invention include aromatic compounds such as toluene and xylene; aliphatic compounds such as n-hexane, cyclohexane, and isoparaffin; ether compounds such as tetrahydrofuran; ketone compounds such as methyl ethyl ketone and cyclohexanone; ester compounds such as acetate esters; and halogen compounds such as 1,1,1-trichloroethane. In order to adjust development rate, the above developers may further contain an appropriate amount of a solvent which cannot dissolve the resin (A) such as ethanol or isopropanol.

The development time, which varies in accordance with the type and amount(s) of the component(s) in the composition, the thickness of coating film, and other factors, is generally 30 to 1,000 seconds. Also, any development method may be employed, the method including dipping, the paddle method, spraying, and shower developing. After development, the remaining resin patter is washed with a flow of water for 30 to 90 seconds, and dried through air blowing by means of a spin drier or an air gum, or through heating on a hot plate, in an oven, or by another means.

### (4) Post-Treatment

The coating film formed from the resin composition of the present invention can be satisfactorily cured through the aforementioned irradiation alone. However, the coating film may be cured to a further extent through additional irradiation (hereinafter referred to as “post light exposure”) or heating.

The post light exposure may be performed in the same manner. No particular limitation is imposed on the radiation dose, and a dose of 100 to 2,000 mJ/cm² is preferred, when a high-pressure mercury lamp is employed. Heating may be performed by means of a heating apparatus such as a hot plate or an oven, at a predetermined temperature (e.g., 60 to 150° C.) for a predetermined time (e.g., 5 to 30 minutes in the case of a hot plate, and 5 to 60 minutes in the case of an oven). Through the post treatment, a cured film having a target pattern and suitable properties can be produced.

### (5) Etching

Various substrates provided with the aforementioned patterned cured film are etched through a known technique. Specific examples of the technique include immersion in an etchant (i.e., wet etching), chemical etching under reduced pressure (i.e., dry etching), and a combination thereof.

Examples of the etchant which may be used in wet etching include hydrofluoric acid, a mixture of hydrofluoric acid and ammonium fluoride, and an acid mixture of hydrofluoric acid and another acid (e.g., hydrochloric acid, sulfuric acid, or phosphoric acid). In dry etching, CF gas, chlorine-containing gas, or the like may be used.

### (6) Removal Through Peeling

After completion of etching, the resist film is peeled from the substrate. The remover (peelant) employed in the removal process may be an alkali component dissolved in a solvent. Examples of the alkali component include inorganic alkalis such as sodium hydroxide and potassium hydroxide; and organic alkalis such as tertiary amines (e.g., trimethanolamine, triethanolamine, or dimethylaniline) and quaternary ammoniums (e.g.,tetramethylammonium hydroxide or tetraethylammonium hydroxide), and examples of the solvent include water, dimethyl sulfioxide, N-methylpyrrolidone, and a mixture thereof. Alternatively, when an aromatic solvent (e.g., toluene, xylene, or limonene) or an aliphatic solvent is used as a remover, a resist film can be removed via swelling.

When these removers are used, a removing technique such as spraying, showering, or the paddle method may be employed. In one specific mode, 2 mass % of tetramethylammonium hydroxide is dissolved in dimethyl sulfoxide, to thereby prepare a remover, and the substrate is immersed for 5 to 30 minutes in the remover heated to 30 to 80° C. under stirring, whereby the resist film can be removed.

### EXAMPLES

The present invention will next be described in detail by way of examples, which should not be construed as limiting the invention thereto.

### Synthesis Example 1

### Polybutadiene-Base Polyurethane Resin [A-1]

To a four-neck flask equipped with a thermometer, a stirrer, a cooling condenser, and a nitrogen gas inlet, both-end-hydroxy-capped hydrogenated polybutadiene (GI-3000, product of Nippon Soda Co. Ltd.) (100 g), isophorone diisocyanate (7 g), cyclohexanone (solvent) (200 g), and dibutyltin dilaurate (catalyst) (0.002 g) were fed, and the mixture was allowed to react overnight at 70° C., to thereby yield a hydrogenated polybutadiene-base polyurethane resin [A-1] [weight average molecular weight: 79,000] as a resin solution.

### Synthesis Example 2 to Synthesis Example 5

The procedure of Example 1 was repeated, except that the amounts of the compounds were altered to those shown in Table 1, to thereby synthesize the resins [A-2] to [A-5].

### Synthesis Example 6

### Alkali-Soluble Group-Incorporated Polybutadiene-Based Polyurethane Resin [A-6]

To a four-neck flask equipped with a thermometer, a stirrer, a cooling condenser, and a nitrogen gas inlet, both-end-hydroxy-capped hydrogenated polybutadiene (GI-3000, product of Nippon Soda Co. Ltd.) (100 g), 2,2-bis(hydroxyethyl)propionic acid (2.7 g), isophorone diisocyanate (18.4 g), cyclohexanone (solvent) (200 g), dibutyltin dilaurate (catalyst) (0.005 g) were fed, and the mixture was allowed to react at 70° C. for 3 hours, to thereby yield a hydrogenated polybutadiene-base polyurethane resin [A-6] [weight average molecular weight: 19,000] as a resin solution.

### Synthesis Example 7

### Polybutadiene-Based Polyester Resin [A-7]

To a flask equipped with a thermometer, a stirrer, a Dean Stark apparatus, and a cooling condenser, both-end-hydroxy-capped hydrogenated polybutadiene (GI-1000, product of Nippon Soda Co. Ltd.) (100 g), terephthaloyl chloride (5.9 g), toluene (solvent) (200 g), and pyridine (catalyst) (6.9 g) were fed, and the mixture was allowed to react overnight at 130° C., to thereby yield a polybutadiene-base polyester resin [A-7] [weight average molecular weight: 49,000] as a resin solution.

### Synthesis Example 8

### (Meth)Acrylate Group-Incorporated Polybutadiene-Based Polyurethane Resin [A-8]

To a four-neck flask equipped with a thermometer, a stirrer, a cooling condenser, and a nitrogen gas inlet, both-end-hydroxy-capped hydrogenated polybutadiene (GI-3000, product of Nippon Soda Co. Ltd.) (100 g), isophorone diisocyanate (17.2 g), cyclohexanone (solvent) (200 g), dibutyltin dilaurate (catalyst) (0.005 g) were fed, and the mixture was allowed to react at 70° C. for 3 hours. Subsequently, isophorone diisocyanate (3.4 g) and 2-hydroxyethyl acrylate (3.6 g) were added thereto, and the mixture was allowed to react at 70° C. for 3 hours, to thereby yield a (meth)acrylate group-incorporated polybutadiene-based polyurethane resin [A-8] [weight average molecular weight: 17,000] as a resin solution.

Table 1 shows the compositions of resin [A-1] to resin [A-8].

TABLE 1

| | | Polybutadiene polyol | | | | | | | (Meth)acrylate | Alkali-soluble | |
|---|---|---|---|---|---|---|---|---|---|---|---|
| | | (a-1) | | | Cross-linking agent (a-2) | | | | group (b) | group (c) | Mol. wt. |
| | | a-1-1 | a-1-2 | a-1-3 | a-2-1 | a-2-2 | a-2-3 | a-2-4 | b-1 | c-1 | Mw |
| Synth. Ex. 1 | Resin [A-1] | 100 | — | — | 7 | — | — | — | — | — | 79,000 |
| Synth. Ex. 2 | Resin [A-2] | 100 | — | — | 13.8 | — | — | — | — | — | 130,000 |
| Synth. Ex. 3 | Resin [A-3] | 100 | — | — | — | 5.3 | — | — | — | — | 60,000 |
| Synth. Ex. 4 | Resin [A-4] | 100 | — | — | — | — | 7.7 | — | — | — | 63,000 |
| Synth. Ex. 5 | Resin [A-5] | — | — | 100 | — | — | 10.3 | — | — | — | 32,000 |
| Synth. Ex. 6 | Resin [A-6] | 100 | — | — | 18.4 | — | — | — | — | 2.7 | 19,000 |
| Synth. Ex. 7 | Resin [A-7] | — | 100 | — | — | — | — | 5.9 | — | — | 49,000 |
| Synth. Ex. 8 | Resin [A-8] | 100 | — | — | 17.2 | — | — | — | 3.6 | — | 17,000 |

a-1-1: both-end-hydroxy-capped hydrogenated polybutadiene (GI-3000, product of Nippon Soda Co. Ltd.)
a-1-2: both-end-hydroxy-capped hydrogenated polybutadiene (GI-1000, product of Nippon Soda Co. Ltd.)
a-1-3: liquid polybutadiene having a hydroxy group at each terminal (R-45HT, product of Idemitsu Kosan Co., Ltd.)
a-2-1: isophorone diisocyanate (product of Tokyo Chemical Industry Co., Ltd.)
a-2-2: hexamethylene diisocyanate (product of Tokyo Chemical Industry Co., Ltd.)
a-2-3: methylenediphenyl 4,4′-diisocyanate (product of Tokyo Chemical Industry Co., Ltd.)
a-2-4: terephthaloyl chloride (product of Tokyo Chemical Industry Co., Ltd.)
b-1: 2-hydroxyethyl acrylate (product of Tokyo Chemical Industry Co., Ltd.)
c-1: 2,2-bis(hydroxyethyl)propionic acid

Resin Compositions [1-1] to [1-8]

Each of the resins [A-1] to [A-8] listed in Synthesis Examples 1 to 8 of Table 1 was dissolved in a solvent, to thereby prepare resin compositions [1-1] to [1-8] for hydrofluoric acid etching shown in Table 2. Among these resin compositions, resin composition [1-8] was yielded by adding a photo-polymerization initiator (C) (3 parts by mass, with respect to 100 parts by mass of resin components (A) and (B)). Also, resin composition [1-9] was yielded by adding, to resin composition [1-8], an ethylenic unsaturated monomer (B) (127 parts by mass, with respect to 100 parts by mass of resin component (A)). Resin composition [1-10] was yielded by using a commercial product, UC-203 (methacryloyl-modified liquid polyisoprene rubber, product of Kuraray Co., Ltd.) as resin (A) and by adding a photo-polymerization initiator (C) (3 parts by mass, with respect to 100 parts by mass of resin components (A) and (B)). As the above solvent, toluene, THF, cyclohexanone, methyl isobutyl ketone, or the like may be used. In the above preparation, cyclohexanone was used.

### Comparative Resin Compositions [2-1] to [2-3]

Each of the resins [A] listed in Table 2 was dissolved in a solvent, to thereby yield comparative resin compositions [2-1] to [2-3]. As the above solvent, toluene, THF, cyclohexanone, methyl isobutyl ketone, or the like may be used. In the above preparation, cyclohexanone was used.

### <Practical Characteristic Evaluation 1>

### (1) Preparation of Substrate Having Protective Film

In Examples 1 to 7 and Comparative Example 1 shown in Table 2, each of resin compositions [1-1] to [1-7] and comparative resin composition [2-1] was applied, by means of a spin coater, onto a silicon substrate having a thermal oxide film (SiO2 film thickness: 300 nm). The substrate was baked at 120° C. for 10 minutes by means of a hot plate, to thereby form a coating film (protective film) having a film thickness of 40 μm. In Comparative Examples 2 and 3, the procedure of Example 1 was repeated, except that comparative resin composition [2-2] or [2-3], prepared by adding 4 mass % of p-toluenesulfonic acid serving as a catalyst to resin composition [1-1], and baking was performed at 220° C. for 5 minutes, to thereby form a coating film (protective film) having a film thickness of 40 μm. In Examples 8 to 10, where the ethylenic unsaturated monomer (B) or the photo-polymerization initiator (C) was added, the procedure of Example 1 was repeated, except that each of resin compositions [1-8] to [1-10] was applied to thereby form a coating film having a film thickness of 40 μm, and the coating film was cured by irradiating the film with a UV ray of 2 J by means of a high-pressure mercury lamp. The surface tackiness of the protective film was evaluated through finger touching. When tackiness was confirmed, the state is denoted by “yes”, and when no tackiness was confirmed, the state is denoted by “no”, in Table 2.

### (2) Etchant (Hydrofluoric Acid Solution) Resistance

Each of the substrates having protective film produced through the aforementioned procedure was immersed in 20% aqueous hydrofluoric acid at 25° C. for 1 hour, and then the protective film was physically peeled. The thickness of thermal oxide film which had been covered with the protective film was measured by means of an ellipsometer (model M-2000, product of J. A. Woollam). The case where the thickness of thermal oxide film was 290 nm or more is rated with “OO”, the case where the thickness was 200 nm or more is rated with “O”, and the case where the thickness was less than 200 nm is rated with “X”.

### (3) Acid/Alkali Resistance

Similar to the etching resistance test, each of resin compositions [1-1] and [1-9] of Examples 1 and 9 was immersed in acidic solutions or alkaline solutions shown in Table 3 for 1 hour, and the washed with water and dried. The case where swelling, dissolution, peeling, or similar degradation was observed in the protective film is rated with “X”, and the case where no such degradation was observed is rated with “O”.

### (4) Patterning Characteristic

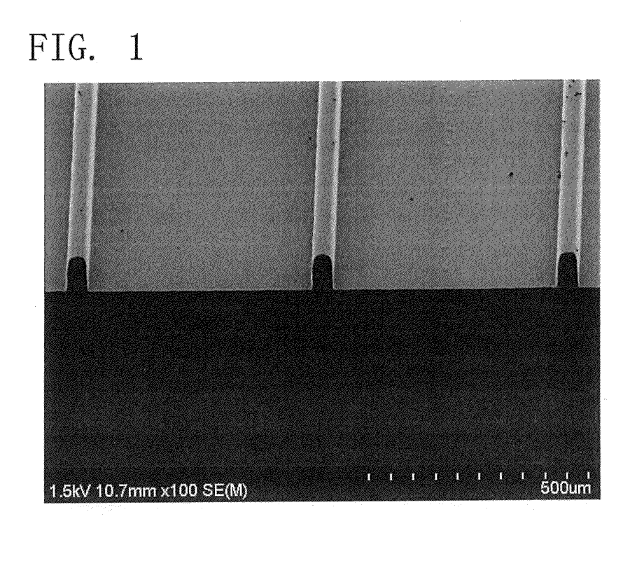

Resin composition [1-9] employed in Example 9 was applied onto a silicon substrate by means of a spin coater, and the substrate was baked at 120° C. for 10 minutes by means of a hot plate. Subsequently, the substrate was irradiated with a UV ray of 2 J by means of a mask-aligner (model MA-6, product of SUSS MicroTec) for forming a cured pattern. Thereafter, the substrate was further baked at 120° C. for 10 minutes, and the unexposed portion was removed with a solvent mixture of methyl isobutyl ketone (60 parts by mass) and isopropanol (40 parts by mass), to thereby produce a substrate having a protective film line pattern (height: about 70 μm, width: about 40 μm). The thus-produced substrate was cleaved to square pieces (4 cm×4 cm), and the shape of the protective film of each piece was observed under a scanning electron microscope. FIG. 1 shows a microphotographic image.

TABLE 2

| | | | Ethylenic | Photo- | | |
|---|---|---|---|---|---|---|
| | | | unsatd. | polymn. | | |
| | | | monomer | initiator | Surface | HF |
| | Resin composition | Resin [A] | (B) | (C) | tackiness | barrier |
| Ex. 1 | Resin composition [1-1] | Resin [A-1] | — | — | yes | ◯◯ |
| Ex. 2 | Resin composition [1-2] | Resin [A-2] | — | — | no | ◯◯ |
| Ex. 3 | Resin composition [1-3] | Resin [A-3] | — | — | yes | ◯◯ |
| Ex. 4 | Resin composition [1-4] | Resin [A-4] | — | — | yes | ◯◯ |
| Ex. 5 | Resin composition [1-5] | Resin [A-5] | — | — | yes | ◯◯ |
| Ex. 6 | Resin composition [1-6] | Resin [A-6] | — | — | no | ◯◯ |
| Ex. 7 | Resin composition [1-7] | Resin [A-7] | — | — | yes | ◯ |
| Ex. 8 | Resin composition [1-8] | Resin [A-8] | — | C-1 | yes | ◯◯ |
| Ex. 9 | Resin composition [1-9] | Resin [A-8] | B-1 | C-1 | yes | ◯ |
| Ex. 10 | Resin composition [1-10] | UC-203 | — | C-1 | no | ◯ |
| Comp. | Comp. resin compn. [2-1] | V-4221 | — | — | no | X |
| Ex. 1 | | | | | | |
| Comp. | Comp. resin compn. [2-2] | G-3000 | — | — | no | X |
| Ex. 2 | | | | | | |
| Comp. | Comp. resin compn. [2-3] | R-45HT | — | — | no | X |
| Ex. 3 | | | | | | |

UC-203: product of Kuraray, methacryloyl-modified liquid isoprene rubber
V-4221: product of DIC, polyester-based polyurethane
G-3000: product of Nippon Soda Co. Ltd., hydroxy-capped (both ends) polybutadiene
R-45HT: product of Idemitsu Kosan Co., Ltd., hydroxy-end-capped liquid polybutadiene
B-1: isodecyl acrylate (product of Sartomer)
C-1: Irgacure 907 (product of BASF)

As is clear from Table 2, resin compositions [1-1] to [1-10], which are those for hydrofluoric acid etching, were firmly attached to the substrate by virtue of excellent adhesion to substrate, even though the compositions contained no silane coupling agent. Also, the resin compositions were found to have excellent hydrofluoric acid barrier property (Examples 1 to 10). In contrast, comparative resin composition [2-1], which is a polyurethane resin (i.e., a non-polybutadiene-based resin), exhibited excellent adhesion but exhibited no hydrofluoric acid barrier property (Comparative Example 1). In the case where a polybutadiene-based resin has no hydrogen bond formed via urethane bonding or ester bonding; i.e., in the case of comparative resin compositions [2-2] and [2-3], no hydrofluoric acid barrier property was attained (Comparative Examples 2 and 3). Since the resins of the embodiments resin are soft resins, the formed film surface may be tacky, in some cases, after baking. However, the tackiness can be controlled by adjusting the amount of hydrogen bonds. More specifically, the film surface can be hard, to thereby remove surface tackiness, by increasing sites for forming hydrogen bonds; e.g., urethane bonds and carboxylic acid groups. In contrast, in the case where hydrogen bond was weak, or the amount of hydrogen bonds is small; i.e., in the cases of resin compositions [1-7], [1-9], and [1-10] for hydrofluoric acid etching, hydrofluoric acid barrier property was found to slightly decrease (Examples 7, 9, and 10).

Notably, Japanese Patent Application Laid-Open (kokai) No. 2010-106048 discloses that the softening point of such a resin is preferably 60° C. or higher, from the viewpoint of heat resistance. However, the resins of the embodiments of the present invention showed no particular problem during etching at 40° C.

As shown in Table 3, the protective film produced from resin composition [1-1] for hydrofluoric acid etching was found to exhibit such an excellent resistance that the film was not degraded even in an aqueous high-concentration acidic or alkaline solution (Example 1). Particularly, although a conventional protective resin film is dissolved in concentrated nitric acid (70%), the protective film of the present embodiment was degraded and exhibited constantly high adhesion to the substrate. Notably, the protective film produced from resin composition [1-9] containing an ethylenic unsaturated monomer (D) for reducing the viscosity of the composition exhibited reduced resistance to nitric acid and was peeled from the substrate after immersion for one hour. However, no degradation such as peeling was observed after immersion for 30 minutes (Example 9).

The protective films of the embodiments can be developed and peeled with an appropriately selected solvent. As shown in FIG. 1, a pattern with high aspect ratio can be obtained through exposure to UV light and development. After etching, the protective films can be readily peeled from the substrate without residue, via swelling of the films with an organic solvent such as xylene or toluene. Actually, when the pattern shown in FIG. 1 was immersed xylene for about 5 seconds, the protective film swelled and was peeled from the substrate. Notably, the protective film produced from resin composition [1-6] prepared from resin [A-6] having an alkali-soluble group can be peeled from the substrate with aqueous alkali (Example 6).

TABLE 3

| | | | No swell, peeling, or dissolution after | |
|---|---|---|---|---|
| | | | immersion for 1 hr (25° C.) | |
| Type | Species | Concn. | Ex. 1 | Ex. 9 |
| Inorg. acid | HF | 20% | ◯ | ◯ |
| | H | 36% | ◯ | ◯ |
| | H₂SO₄ | 60% | ◯ | ◯ |
| | HNO₃ | 70% | ◯ | X |
| Inorg. alkali | KOH | 20% | ◯ | ◯ |
| | Na₂CO₃ | 20% | ◯ | ◯ |
| | NaOH | 20% | ◯ | ◯ |

Resin Compositions [1-11] to [1-24], and [1-28]

The same reactor and equipment as employed in Example 1 were employed. An urethane acrylate component (40 parts by mass), which is an 80 mass % component of UV-3630ID80 (product of The Nippon Synthetic Chemical Industry Co., Ltd.), was used as resin (A). Isodecyl acrylate (acrylic adhesive, SR395, product of Sartomer) (160 parts by mass) (including isodecyl acrylate, which is a 20 mass % component of UV-3630ID80); dicyclopentanyl methacrylate (FA-513M, product of Hitachi Chemical Co., Ltd.) (250 parts by mass); trimethylolpropane triacrylate (cross-linking agent, A-TMPT, product of Shin-Nakamura Chemical Co., Ltd.) (10 parts by mass); and a photo-polymerization initiator (Irgacure 369, product of BASF) were dissolved in the resin (A), and the mixture was stirred at room temperature, to thereby provide a uniform mixture, which was employed as resin composition [1-11] shown in Table 4, for hydrofluoric acid etching. The amount of polyurethane resin incorporated into resin composition [1-11] was adjusted to 9 parts by mass, with respect to the total solid content.

The procedure of producing resin composition [1-11] was repeated, except that the amounts of the compounds and the amount of polyurethane resin with respect to the total solid content were changed as shown in Table 4, to thereby produce resin compositions [1-12] to [1-24], and [1-28] for hydrofluoric acid etching shown in Table 4. Resin composition [1-16] was obtained by using methanol as a diluent.

Comparative Resin Compositions [2-5] to [2-12]

The type and amounts of the compounds were changed as shown in Table 4, and the components were dissolved in a solvent, to thereby produce comparative resin compositions [2-5] to [2-12]. These compositions contained no resin [A].

In the resin compositions and comparative resin compositions, the photo-polymerization initiator (C) content with respect to 100 parts by mass of the total amount of resin [A], the acrylic adhesive, and the cross-linking agent was adjusted to 3 parts by mass. In the cases of resin compositions [1-24] and [1-28], two photo-polymerization initiators (C) were used in combination, and the photo-polymerization initiator (C) content with respect to 100 parts by mass of the total amount was adjusted to 14 parts by mass; i.e., 6 parts by mass and 8 parts by mass, respectively.

TABLE 4

| | | Type of | | Acrylic adhedsive | | | | Photopolymn. | | |
|---|---|---|---|---|---|---|---|---|---|---|
| | | Resin | Resin | SR | FA- | FA- | FA- | initiator (C) | | Diluent |
| | Resin compn. | [A] | [A] | 395 | 513M | 513AS | 511AS | C-2 | C-3 | MeOH |
| Ex. | | | | | | | | | | |
| 11 | Resin compn. | UV- | 40 | 160 | 250 | — | — | 3 parts | — | — |
| | [1-11] | 3630 | | | | | | by mass | | |
| 12 | Resin compn. | ID80 | 40 | 160 | 150 | — | — | to 100 | | — |
| | [1-12] | | | | | | | parts by | | |
| 13 | Resin compn. | | 40 | 160 | 150 | — | — | mass of | | — |
| | [1-13] | | | | | | | resin [A], | | |
| 14 | Resin compn. | | 40 | 160 | 150 | — | — | acrylic | | — |
| | [1-14] | | | | | | | adhesive, | | |
| 15 | Resin compn. | | 40 | 160 | 150 | — | — | and | | — |
| | [1-15] | | | | | | | cross- | | |
| 16 | Resin compn. | | 40 | 70 | — | — | — | linking | | 250 |
| | [1-16] | | | | | | | agent | | |
| 17 | Resin compn. | UV- | 44 | 67 | 108 | — | — | | | — |
| | [1-17] | 3635 | | | | | | | | |
| 18 | Resin compn. | ID80 | 44 | 67 | 85 | — | — | | | — |
| | [1-18] | | | | | | | | | |
| 19 | Resin compn. | | 44 | 67 | 62 | — | — | | | — |
| | [1-19] | | | | | | | | | |
| 20 | Resin compn. | | 44 | 67 | 0 | — | — | | | — |
| | [1-20] | | | | | | | | | |
| 21 | Resin compn. | | 44 | 67 | 0 | — | — | | | — |
| | [1-21] | | | | | | | | | |
| 22 | Resin compn. | | 44 | 67 | 39 | — | — | | | — |
| | [1-22] | | | | | | | | | |
| 23 | Resin compn. | | 44 | 67 | 0 | — | — | | | — |
| | [1-23] | | | | | | | | | |
| 24 | Resin compn. | | 32 | 408 | 400 | — | — | 6 parts | 8 parts | — |
| | [1-24] | | | | | | | by mass | by mass | |
| 28 | Resin compn. | | 40 | 310 | 0 | 100 | 350 | | | — |
| | [1-28] | | | | | | | | | |
| Comp. Ex | | | | | | | | | | |
| 5 | Comp. resin | — | — | 50 | 0 | — | — | 3 parts | — | — |
| | compn. [2-5] | | | | | | | by mass | | |
| 6 | Comp. resin | | — | 50 | — | — | — | to 100 | | — |
| | compn. [2-6] | | | | | | | parts by | | |
| 7 | Comp. resin | | — | 50 | — | — | — | mass of | | — |
| | compn. [2-7] | | | | | | | resin [A], | | |
| 8 | Comp. resin | | — | 60 | — | — | — | acrylic | | — |
| | compn. [2-8] | | | | | | | adhesive, | | |
| 9 | Comp. resin | | — | 10 | — | — | — | and | | — |
| | compn. [2-9] | | | | | | | cross- | | |
| 10 | Comp. resin | | — | 60 | 40 | — | — | linking | | — |
| | compn. [2-10] | | | | | | | agent | | |
| 11 | Comp. resin | | — | 50 | 50 | — | — | | | — |
| | compn. [2-11] | | | | | | | | | |
| 12 | Comp. resin | | — | 40 | 60 | — | — | | | — |
| | compn. [2-12] | | | | | | | | | |

| | | | | | | Substrate | | |
|---|---|---|---|---|---|---|---|---|
| | Cross-linking agent | | | | Resin [A] | adhesion | | |
| | A- | | A- | A- | amount to | after | Peeling | HF |
| | TMPT | HD-N | NOD-N | HD-N | solid | etching | removability | barrier |
| Ex. | | | | | | | | |
| 11 | 10 | — | — | — | 9 | ◯ | ◯ | ◯ |
| 12 | 40 | — | — | — | 10 | ◯ | ◯ | ◯ |
| 13 | 30 | — | — | — | 11 | ◯ | ◯ | ◯ |
| 14 | 20 | — | — | — | 11 | ◯ | ◯ | ◯ |
| 15 | 10 | — | — | — | 11 | ◯ | ◯ | ◯ |
| 16 | 10 | — | — | — | 33 | ◯ | ◯ | ◯ |
| 17 | 0 | — | — | — | 20 | ◯ | ◯ | ◯ |
| 18 | 0 | — | — | — | 22 | ◯ | ◯ | ◯ |
| 19 | 0 | — | — | — | 25 | ◯ | ◯ | ◯ |
| 20 | 45 | — | — | — | 28 | ◯ | ◯ | ◯ |
| 21 | 0 | — | — | — | 40 | ◯ | ◯ | ◯ |
| 22 | 30 | — | — | — | 24 | ◯ | ◯ | ◯ |
| 23 | 15 | — | — | — | 35 | ◯ | ◯ | ◯ |
| 24 | 80 | — | — | — | 3 | ◯ | ◯ | ◯ |
| 28 | 60 | — | — | — | 4 | ◯ | ◯ | ◯ |
| Comp. Ex | | | | | | | | |
| 5 | — | 50 | — | — | — | X | — | — |
| 6 | — | — | 50 | — | — | X | — | — |
| 7 | — | — | — | 50 | — | X | — | — |
| 8 | — | — | — | 40 | — | X | — | — |
| 9 | 1 | — | — | — | — | X | — | — |
| 10 | — | — | — | — | — | ◯ | ◯ | X |
| 11 | — | — | — | — | — | ◯ | ◯ | X |
| 12 | — | — | — | — | — | ◯ | ◯ | X |

UV-3630ID80: product of The Nippon Synthetic Chemical Industry Co., Ltd., hydrogenated polybutadiene-based urethane acrylate
UV-3635ID80: product of The Nippon Synthetic Chemical Industry Co., Ltd., hydrogenated polybutadiene-based urethane acrylate
SR395: product of Sartomer, isodecyl acrylate
FA-513M: product of Hitachi Chemical Co., Ltd., dicyclopentanyl methacrylate
FA-513AS: product of Hitachi Chemical Co., Ltd., dicyclopentanyl acrylate
FA-511AS: product of Hitachi Chemical Co., Ltd., dicyclopentenyl acrylate
C-2: product of BASF, Irgacure 369
C-3: product of BASF, Darocure 1173
A-TMPT: product of Shin-Nakamura Chemical Co., Ltd., trimethylolpropane triacrylate
HD-N: product of Shin-Nakamura Chemical Co., Ltd., 1,6-hexanediol dimethacrylate
A-NOD-N: product of Shin-Nakamura Chemical Co., Ltd., 1,9-nonanediol diacrylate
A-HD-N: product of Shin-Nakamura Chemical Co., Ltd., 1,6-hexanediol diacrylate

### <Practical Characteristic Evaluation 2>

### (1) Preparation of Substrate Having Protective Film

In Examples 11 to 24, and 28, and Comparative Examples 5 to 12 shown in Table 4, each of resin compositions [1-11] to [1-24], and [1-28], and comparative resin compositions [2-5] to [2-12] was applied, through spin coating or casting, onto a silicon substrate having a thermal oxide film (SiO₂ film thickness: 300 nm). The substrate was baked at 120° C. for 10 minutes by means of a hot plate, to thereby form a coating film (protective film) having a film thickness of 30 μm. The substrate was then irradiated with UV light (15 mW/cm², 1.0 J) under nitrogen, to thereby cure the coating film (protective film).

### (2) Etchant (Hydrofluoric Acid Solution) Resistance

Each of the substrates having protective film produced through the aforementioned procedure was immersed in an aqueous solution containing 9% hydrofluoric acid and 10% hydrochloric acid (hereinafter may be referred to as etchant) at 25° C. The substrate was subjected to etching for 3 minutes, while the substrate was manually shaken. The case where the protective film was attached to the substrate even after etching is rated with “O”, whereas the case where the protective film was peeled from the substrate during etching is rated with “X”.

### (3) Peeling Removability

The same etching treatment as performed in the etchant resistance test was carried out. After etching, the substrate was washed with water, and an attempt was made to peel the protective film from the substrate. The case where the protective film could be manually peeled from the substrate was rated as “O”, whereas the case where the protective film could not be manually peeled from the substrate was rated as “X”.

### (4) Hydrofluoric Acid Barrier Property

The same etching treatment as performed in the etchant resistance test was carried out. Occurrence of corrosion of the substrate (SiO2) caused by the etchant was visually checked. The case where no SiO2 corrosion was observed was rated as “O”, whereas the case where SiO2 corrosion was observed was rated as “X”.

As shown in Table 4, even though the type, amount, etc. of the resin [A] were considerably varied in preparation of resin compositions for hydrofluoric acid etching, resin compositions [1-11] to [1-24], and [1-28] were found to exhibit excellent characteristics (adhesion to substrate after etching, peeling removability, and hydrofluoric acid barrier property) (Examples 11 to 24, and 28). Also, resin composition [1-16] containing an organic solvent (methanol) as a diluent was found to cause no problem in exposure to UV light after evaporation of the solvent during baking of the substrate (at 100° C. for 10 minutes) after application of the resin composition (Example 16). In contrast, comparative resin compositions [2-5] to [2-9] exhibited good adhesion to the substrate after exposure to UV light, but were not durable to etching, resulting in peeling off (Comparative Examples 5 to 9). In addition, comparative resin compositions [2-10] to [2-12] were durable to the etching procedure, concomitant with no peeling, but hydrofluoric acid penetrated the film, resulting in corrosion of SiO2 (Comparative Examples 10 to 12).

As described above, an acrylic adhesive is generally degraded by hydrochloric acid or sulfuric acid contained in an etchant or the like. Thus, when an acrylic adhesive is employed in a resin composition for hydrofluoric acid etching, hydrofluoric acid (HF) penetrates the cured resin film, and the film is peeled by corrosion of the substrate. Furthermore, the resin film may be dissolved by the action of hydrochloric acid (HCl) or sulfuric acid (H2SO4) contained in the etchant. In contrast, resin compositions [1-11] to [1-24], and [1-28] for hydrofluoric acid etching exhibit hydrofluoric acid barrier property and excellent etching characteristics (adhesion to substrate after etching and peeling removability), whereby the above problems can be solved.

Estimating from the excellent characteristics (adhesion to substrate after etching and peeling removability) of resin compositions [1-11] to [1-24], and [1-28] for hydrofluoric acid etching, the resin composition of the present embodiment further containing an acrylic adhesive can more readily realize a resin composition for hydrofluoric acid etching having a low viscosity (e.g., <0.02 Pa-s). By use of such a resin composition, any coating method may be chosen, whereby enhanced coatability and other advantages can be attained.

Resin Compositions [1-25] to [1-27]

Diethylene glycol dibutyl ether (product of Junsei Chemical Co., Ltd.) serving as a solvent (30.1 parts by mass) was placed in a polypropylene cup, and Aerosil 200 (product of Nippon Aerosil Co., Ltd.) serving as the thixotropy-imparting agent (I) (2.0 parts by mass) and BYK-405 (product of BYK Japan K.K.) (0.7 parts by mass) were added, with mixing by means of a disper (product of Primix Corporation, Robomix equipped with Homodisper Attachment). To this mixture, an urethane acrylate component (36.2 parts by mass), which is an 80 mass % component of UV-3630ID80 (product of The Nippon Synthetic Chemical Industry Co., Ltd.) serving as resin (A), isodecyl acrylate (SR395, product of Sartomer) serving as an ethylenic unsaturated monomer (B) (9.0 parts by mass) (including isodecyl acrylate, which is a 20 mass % component of UV-3630ID80), and Perhexa HC (product of NOF Corporation) serving as a thermal radical polymerization initiator (2.7 parts by mass) were added. The resultant mixture was further stirred by means of a disper and kneaded at room temperature by means of a triple roller mill (model: NR-42A, product of Noritake Co., Ltd.) to provide a homogeneous resin composition for screen printing and hydrofluoric acid etching. The resin composition was resin composition [1-25] shown in Table 5.

The procedure of producing resin composition [1-25] was repeated, except that the amounts of the compounds were changed as shown in Table 5, to thereby produce resin compositions [1-26] and [1-27] for hydrofluoric acid etching shown in Table 5.

In the above production, diethylene glycol dibutyl ether was used as a solvent. However, other high-boiling-point solvents such as diethylene glycol monobutyl ether and diethylene glycol monohexyl ether may also be used.

TABLE 5

| | | | | Ethylenic | | Thixotropy- | | | | | | | | |
|---|---|---|---|---|---|---|---|---|---|---|---|---|---|---|
| | | | | unsatd. | Solvent | imparting | | Thermal polymn. | | | | | | Peeling of |
| | | Type of | | monomer | Di-EG | agent | | initiator | | | | Print- | | protective |
| | | Resin | Resin | (B) | dibutyl | Aerosil | BYK- | Perhexa | | Viscosity [Pa · s] | | abil- | HF | film after |
| | Resin compn. | [A] | [A] | SR395 | ether | 200 | 405 | HC | MAIB | 5 rpm | 50 rpm | ity | barrier | etching |
| Ex. 25 | Resin compn. | UV- | 36.2 | 9 | 30.1 | 2 | 0.7 | 2.7 | — | 5 | 2.6 | ◯ | ◯ | OK |
| | [1-25] | 3630 | | | | | | | | | | | | |
| Ex. 26 | Resin compn. | ID80 | 36.2 | 9 | 30.1 | 3 | 1.2 | 2.7 | — | 7.1 | 2.9 | ◯ | ◯ | OK |
| | [1-26] | | | | | | | | | | | | | |
| Ex. 27 | Resin compn. | | 34.1 | 8.5 | 43 | 5.4 | 1.9 | — | 2.1 | 15 | 3.4 | ◯ | ◯ | OK |
| | [1-27] | | | | | | | | | | | | | |

UV-3630ID80: product of The Nippon Synthetic Chemical Industry Co., Ltd., hydrogenated polybutadiene-based urethane acrylate
SR395: product of Sartomer, isodecyl acrylate
MAIB: product of Tokyo Chemical Industry Co., Ltd., dimethyl 2,2′-azobis(2-methylpropionate)

### <Practical Characteristic Evaluation 3>

### (1) Thixotropic Property

The viscosity of each of the resin compositions [1-25] to [1-27] of Examples 25 to 27 shown in Table 5 was measured by means of a rheometer (model MCR-302, product of Anton Paar, jig: cone plate CP25-2 (cone angle: 2°)) at plate rotation speeds of 5 rpm and 50 rpm.

### (2) Screen Printability

Each of the resin compositions [1-25] to [1-27] of Examples 25 to 27 shown in Table 5 was printed as a solid square pattern (10 cm×10 cm) on a soda glass substrate by means of a screen printing apparatus (model: MT-320TVC, 3D mesh #250, product of Micro-tec Co., Ltd.). The case where printing could be performed without any problem is rated with “O”, whereas the case where printing failure such as image sticking or bleeding occurred is rated with “X”.

### (3) Etchant (Hydrofluoric Acid Solution) Resistance

The soda glass substrate having a protective film and produced through the above method (Practical characteristic evaluation 3 (2)) was heated in an oven at 150° C. for 10 minutes, to thereby thermally cure the protective film. Then, the substrate was immersed in an aqueous solution containing 10% aqueous hydrofluoric acid (etchant) at 25° C. The substrate was subjected to etching for 10 minutes, while the substrate was manually shaken. The case where the protective film was attached to the substrate even after etching is rated with “O”, whereas the case where the protective film was peeled from the substrate during etching is rated with “X”.

As shown in Table 5, all of the resin compositions [1-25] to [1-27] of Examples 25 to 27 exhibited considerably reduced viscosity at a plate rotation rate of 50 rpm, as compared with 5 rpm, indicating that favorable thixotropic property was attained. By virtue of such a thixotropic property, favorable screen printing could be realized. The protective film produced through the above method (Practical characteristic evaluation 3 (2)) exhibited excellent resistant to etchant. Even though the protective film contained fumed silica, dissolvable in the etchant, no pinhole or other defects were observed after glass etching. The reason for this is that fumed silica was buried in the resin (A) having high hydrofluoric acid barrier property.

As a remover, a mixture of d-limonene (product of Tokyo Chemical Industry Co., Ltd.) (43 parts by mass) and NMP (N-methylpyrrolidone, product of Tokyo Chemical Industry Co., Ltd.) (57 parts by mass) was prepared. The remover was heated at 40° C., and each of resin compositions [1-25] to [1-27] of Examples 25 to 27 shown in Table 5 after glass etching was immersed in the remover. While the substrate was manually shaken, the protective film could be peeled from the substrate within 4 minutes without any residue (“OK” in Table 5). Notably, the remover employed in the evaluation was less stimulative than the hydrofluoric acid etchant.

Resin Compositions [1-29] to [1-35]

The resin composition of the present invention[1-28] (100 parts by mass) serving as a base resin was placed in a glass sample bottle. Dextrin palmitate (product of Nikko Chemicals Co., Ltd.) in powder state (3 parts by mass) serving as the gelling agent (J). The sample bottle was capped and shaken for agitation, to thereby prepare resin composition [1-29] shown in Table 6.

The procedure of producing resin composition [1-29] was repeated, except that the amounts of the compounds and other factors are changed to the compositions shown in Table 6, to thereby produce resin compositions [1-30] to [1-34] for hydrofluoric acid etching shown in Table 6.

The gelling agent (J) was prepared by mixing 12-hydroxystearic acid (product of Johnson Co., Ltd.) (10 parts by mass) with ethanol serving as an organic solvent (34 parts by mass) and heating the mixture at 100° C. to dissolve the acid. The thus-prepared ethanol solution of the gelling agent was mixed with resin composition [1-28] (100 parts by mass) at room temperature, to thereby prepare resin composition [1-35] shown in Table 6.

In the above step, ethanol was used as a solvent. However, other solvents such as ethyl acetate and methyl ethyl ketone may also be used, so long as they can dissolve the gelling agent.

TABLE 6

| | | | Gelling | Gelling | | | |
|---|---|---|---|---|---|---|---|
| | | Base | agent (J) | agent | Solvent | Prebake | Gel |
| | Resin compn. | resin | Type | (J) | EtOH | temp. | strength |
| Ex. 29 | Resin compn. | Resin compn. | J-1 | 3 | — | 100° C. | Δ |
| | [1-29] | [1-28] | | | | | |
| Ex. 30 | Resin compn. | 100 | | 5 | | | ◯ |
| | [1-30] | | | | | | |
| Ex. 31 | Resin compn. | | | 10 | | | ◯ |
| | [1-31] | | | | | | |
| Ex. 32 | Resin compn. | | J-2 | 3 | | 80° C. | ◯ |
| | [1-32] | | | | | | |
| Ex. 33 | Resin compn. | | | 5 | | | ◯ |
| | [1-33] | | | | | | |
| Ex. 34 | Resin compn. | | | 10 | | | ◯ |
| | [1-34] | | | | | | |
| Ex. 35 | Resin compn. | | | 10 | 34 | | ◯ |
| | [1-35] | | | | | | |

J-1: product of Nikko Chemicals Co., Ltd., dextrin palmitate
J-2: product of Johnson Co., Ltd., 12-hydroxystearic acid

### <Practical Characteristic Evaluation 4>

(1) Gelling Property

Each of resin compositions [1-29] to [1-35] of Examples 29 to 35 shown in Table 6 was applied onto a soda glass substrate to a coating film thickness of about 60 μm and heated for one minute at a prebake temperature shown in Table 6. Subsequently, the substrate was cooled to room temperature (25° C.), to thereby form a gel of the resin composition. The case where uniform gel was formed is rated with “O”, the case where uniform gel having low gel strength and collapsiblity (by shock or the like) was formed is rated with “Δ”, and the case where no gelling occurred when cooled to room temperature is rated with “X”. Table 6 shows the results. All the resin compositions of Examples 29 to 35 were found to form gel and attain favorable uniformity in film thickness.

### (2) UV Curability

Each of the gel-form resin compositions [1-31] and [1-34] produced in the above gelling property evaluation was exposed to UV light (20 mW/cm², 2.0 J), to thereby cure the resin composition. The cured product has softness and no surface tackiness, indicating excellent curability.

### (3) Developability

The UV cured product of resin composition [1-34] obtained through the above method (Practical characteristic evaluation 4(2) was immersed in 3% aqueous potassium hydroxide. The unexposed portion underwent gel collapsing by alkali immersion for about 30 seconds, to thereby provide a corresponding liquid resin composition. Thus, the resin was removed from the substrate. In contrast, the UV-exposed portion exhibited no change such as swelling when immersed in aqueous potassium hydroxide, indicating that the resin composition can be patterned through light exposure and development.

(4) Etchant (Hydrofluoric Acid Solution) Resistance and Peeling Removability

A silicon substrate having a thermal oxide film (SiO₂ film thickness: 300 nm) provided with an additional protective film was produced through the above method (Practical characteristic evaluation 4(3). The substrate was immersed in 10% aqueous hydrofluoric acid (etchant) at 25° C., to thereby perform etching for 5 minutes, while the substrate was manually shaken. Then, the substrate was washed with water. After completion of the above procedure, the protective film remained adhered to the substrate even after etching, indicating excellent adhesion. Also, the protective film was readily peeled from the substrate. The portion which was covered with the protective film underwent no corrosion of the substrate (SiO₂) during etching, indicating excellent hydrofluoric acid barrier property.

Resin Compositions [1-36] to [1-39]

Compounds in respective amounts (parts by mass) shown in Table 7 were placed in a glass sample bottle, and the sample bottle was capped and shaken for agitation, to thereby prepare resin compositions [1-36] to [1-39] shown in Table 7. Notably, in Table 7, isodecyl acrylate contained in UV-3630ID80 in an amount of 20 mass % is included in the amount (parts by mass) of SR395.

### <Practical Characteristic Evaluation 5>

### (1) Enhancement of Etchant Resistance by Emulsifying Agent

Each of resin compositions [1-36] to [1-39] of Examples 36 to 39 shown in Table 7 was applied onto a silicon substrate having a thermal oxide film (SiO₂ film thickness: 300 nm) to a coating film thickness of about 60 μm. The substrate was heated at 80° C. for 2 minutes and then cooled to room temperature (25° C.), to thereby form a gel of the resin composition. Subsequently, the resin was irradiated with UV light (60 mW/cm², 2.0 J) and further heated at 110° C. for 10 minutes. The thus-produced substrate provided with a protective film was immersed in 10% aqueous hydrofluoric acid (etchant) at 25° C., while the etchant was stirred at 50 rpm by means of a stirrer, whereby etching was performed for 140 minutes. The substrate was then washed with water. The protective film was peeled off from the substrate.

The etched substrate was evaluated. In all cases of Examples 36 to 39, the portion covered with the protective film underwent no corrosion of the substrate (SiO₂) during etching, indicating excellent hydrofluoric acid barrier property. The corrosion of SiO₂ was evaluated through checking the thickness of SiO₂ through ellipsometry. The case where no change in film thickness before and after etching was observed is rated as “no corrosion”, and the case a change in film thickness before and after etching was observed is rated as “corrosion”.

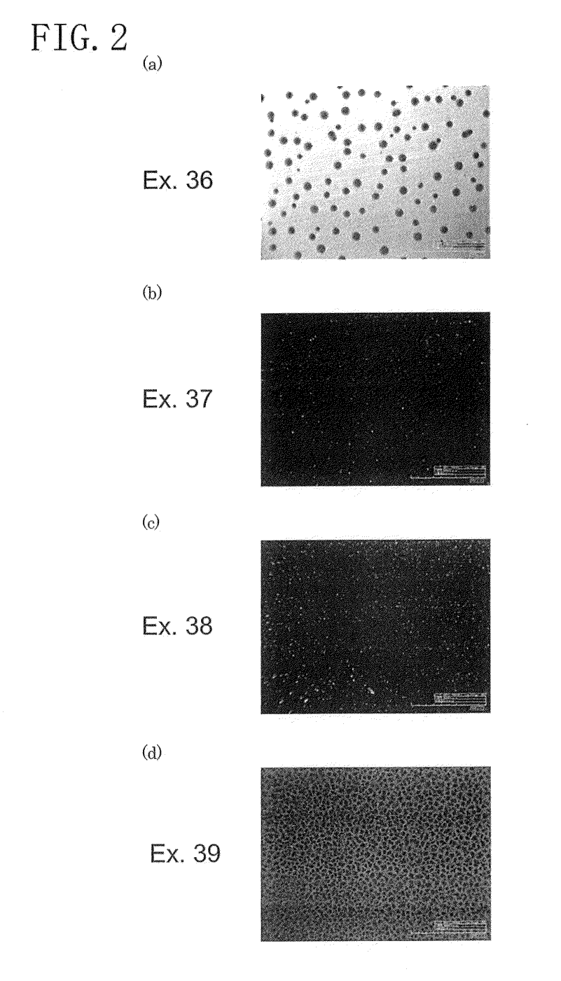

FIG. 2 shows the surfaces of respective SiO₂ film samples observed under an optical microscope. In Example 36, in which no emulsifying agent was employed, a number of holes having a diameter of about 200 μm were observed. In this case, the resin composition of the present invention exhibited excellent hydrofluoric acid barrier property. However, conceivably, when the resin composition has poor compatibility with the gelling agent, or the gel is formed under inappropriate conditions, micro-phase separation occurs in the cured film, and hydrofluoric acid barrier property is locally impaired, resulting in corrosion of SiO₂ film. In Example 36, although a surfactant was employed, micro-phase separation was not prevented. In contrast, in Examples 37 and 38, by virtue of use of an emulsifying agent, no hole was observed in the SiO₂ film. Similarly, in Example 39 employing an emulsifying agent, a very small number of holes were observed in the SiO₂ film, but the diameter and depth of such a hole were considerably smaller than those observed in Example 36. Therefore, through incorporation of an emulsifying agent, uniformity in cured film quality and hydrofluoric acid barrier property were found to be enhanced.

TABLE 7

| | | | | Acrylic adhesive | | | Photopolymn. | | Gelling | | Surfactant | Emulsifier (L) | | |
|---|---|---|---|---|---|---|---|---|---|---|---|---|---|---|
| | | Type of | Resin | SR | FA- | | initiator (C) | | agent (J) | Solvent | (D) | KF- | | |
| Ex. | Resin compn. | Resin [A] | [A] | 395 | 513AS | DPHA | C-4 | C-5 | J-2 | PGME | F-570 | 6012 | 0-20 | L-9A |
| Ex. 36 | Resin compn. | UV-3635 | 16.0 | 4.0 | 80.0 | 9.0 | 9.8 | 3.3 | 6.5 | 43.1 | 0.6 | — | — | — |
| | [1-36] | ID80 | | | | | | | | | | | | |
| Ex. 37 | Resin compn. | | | | | | | | | | | 1.1 | — | — |
| | [1-37] | | | | | | | | | | | | | |
| Ex. 38 | Resin compn. | | | | | | | | | | | — | 1.1 | — |
| | [1-38] | | | | | | | | | | | | | |
| Ex. 39 | Resin compn. | | | | | | | | | | | — | — | 1.1 |
| | [1-39] | | | | | | | | | | | | | |

UV-3635ID80: product of The Nippon Synthetic Chemical Industry Co., Ltd., hydrogenated polybutadiene-based urethane acrylate
SR395: product of Sartomer, isodecyl acrylate
FA-513M: product of Hitachi Chemical Co., Ltd., dicyclopentanyl methacrylate
DPHA: product of Nippon Kayaku Co., Ltd., KAYARAD DPHA
C-4: product of BASF, Irgacure 127
C-5: product of BASF, Lucirin TPO
J-2: product of Johnson Co., Ltd., 12-hydroxystearic acid
F-570: product of DIC, Megafac F-570
KF-6012: product of Shin-Etsu Silicones Co., Ltd., modified silicone oil KF-6012
O-20: products of Toho Chemical Industry Co., Ltd., Pegnol O-20
l-9A: Pegnol l-9A

1. A method for producing a substrate having a pattern, characterized in that the method comprises a step of forming a resist film by applying, onto a substrate, a composition containing a resin as component (A), the resin being formed through reaction between a polyol (a1) and a cross-linking agent (a2), the polyol (a1) being selected from among a polybutadiene polyol, a hydrogenated polybutadiene polyol, a polyisoprene polyol, and a hydrogenated polyisoprene polyol, and a step of patterning, through etching, the substrate on which the resist film has been formed.

2. A substrate production method according to claim 1, wherein the reaction between the polyol (a1) and the cross-linking agent (a2) is ester bond formation reaction.

3. A substrate production method according to claim 1, wherein the reaction between the polyol (a1) and the cross-linking agent (a2) is urethane bond formation reaction.

4. A substrate production method as described in claim 1, wherein the polyol (a1) is a hydrogenated polybutadiene polyol.

5. A substrate production method as described in claim 1, wherein the resin serving as component (A) further has a (meth)acrylate group.

6. A substrate production method as described in claim 1, wherein the resin serving as component (A) further has an alkali-soluble group.

7. A substrate production method according to claim 1, wherein the composition further contains an ethylenic unsaturated monomer (B).

8. A substrate production method according to claim 7, wherein the ethylenic unsaturated monomer (B) is a C≧6 aliphatic or alicyclic alkyl (meth)acrylate.

9. A substrate production method according to claim 1, wherein the composition further contains at least one member selected from the group consisting of a photo-polymerization initiator (C) and a thermal-polymerization initiator (H).

10. A substrate production method according to claim 1, wherein the composition further contains a gelling agent (J).

11. A substrate production method according to claim 1, wherein the composition further contains a thixotropy-imparting agent (I).

12. A substrate production method according to claim 1, wherein the composition further contains an acrylic adhesive (G).

13. A substrate production method according to claim 12, wherein the acrylic adhesive (G) is composed of at least one (meth)acrylate selected from the group consisting of lauryl (meth)acrylate, isodecyl (meth)acrylate, 2-ethylhexyl (meth)acrylate, n-butyl (meth)acrylate, isobornyl (meth)acrylate, n-octyl (meth)acrylate, dicyclopentanylethyl (meth)acrylate, dicyclopentanyl acrylate, adamantyl (meth)acrylate, 2-methyl-2-adamantyl (meth)acrylate, and 2-ethyl-2-adamantyl (meth)acrylate.

14. A substrate production method according to claim 12, wherein the composition contains the acrylic adhesive in an amount of 50 to 3,300 parts by mass, with respect to 100 parts by mass of the resin serving as component (A).

15. A substrate production method according to claim 1, wherein the composition further contains an emulsifying agent (K).

16. A substrate production method according to claim 1, wherein the composition is applied through spin coating, slit coating, roller coating, screen printing, or applicator coating.

17. A substrate production method according to claim 1, wherein the substrate is a glass substrate.

18. A substrate production method according to claim 1, wherein the substrate is a substrate coated with an insulating layer containing silicon.

19. A substrate production method according to claim 18, wherein the insulating layer containing silicon is formed of SiO₂ or SiN.

20. A substrate production method according to claim 1, wherein the etching is wet etching.

21. A substrate produced through a production method as recited in claim 1.

22. An electronic part employing a substrate as recited in claim 21.

23. A composition for hydrofluoric acid etching, the composition being a resist resin composition and comprising a resin, as component (A), the resin being produced through reaction between a polyol (a1) and a cross-linking agent (a2), the polyol (a1) being selected from among a polybutadiene polyol, a hydrogenated polybutadiene polyol, a polyisoprene polyol, and a hydrogenated polyisoprene polyol.

24. A resin composition for hydrofluoric acid etching according to claim 23, which composition further contains an acrylic adhesive (G).

25. A resin composition for hydrofluoric acid etching according to claim 24, wherein the acrylic adhesive (G) is composed of at least one (meth)acrylate selected from the group consisting of lauryl (meth)acrylate, isodecyl (meth)acrylate, 2-ethylhexyl (meth)acrylate, n-butyl (meth)acrylate, isobornyl (meth)acrylate, n-octyl (meth)acrylate, dicyclopentanylethyl (meth)acrylate, dicyclopentanyl acrylate, adamantyl (meth)acrylate, 2-methyl-2-adamantyl (meth)acrylate, and 2-ethyl-2-adamantyl (meth)acrylate.

26. A resin composition for hydrofluoric acid etching according to claim 24, which composition contains the acrylic adhesive in an amount of 50 to 3,300 parts by mass, with respect to 100 parts by mass of the resin serving as component (A).

27. A resin composition for hydrofluoric acid etching according to claim 23, which composition further contains at least one member selected from the group consisting of a photo-polymerization initiator (C) and a thermal-polymerization initiator (H).

28. A resin composition for hydrofluoric acid etching according to claim 23, which composition further contains a gelling agent (J).

29. A resin composition for hydrofluoric acid etching according to claim 23, which composition further contains an emulsifying agent (K).

30. A resin composition for hydrofluoric acid etching according to claim 23, which composition further contains a thixotropy-imparting agent (I).
